(19) United States
(12) Patent Application Publication
(10) Pub. No.: US 2025/0036964 A1
(43) Pub. Date: Jan. 30, 2025

(54) COMMUNICATION METHOD AND RELATED APPARATUS

(71) Applicant: HUAWEI TECHNOLOGIES CO., LTD., Shenzhen (CN)

(72) Inventors: Jian Wang, Hangzhou (CN); Chen Xu, Hangzhou (CN); Gongzheng Zhang, Hangzhou (CN); Rong Li, Boulogne Billancourt (FR); Min Yan, Shenzhen (CN)

(73) Assignee: HUAWEI TECHNOLOGIES CO., LTD., Shenzhen (CN)

(21) Appl. No.: 18/912,516

(22) Filed: Oct. 10, 2024

Related U.S. Application Data
(63) Continuation of application No. PCT/CN2023/086876, filed on Apr. 7, 2023.

(30) Foreign Application Priority Data
Apr. 11, 2022 (CN) 202210375312.5

(51) Int. Cl. G06N 3/098

(52) U.S. Cl. CPC G06N 3/098

(57) ABSTRACT

This application provides a communication method and a related apparatus. In this method, a first neural network model may be determined from one or more pre-trained neural network models, the first neural network model is adjusted based on communication resource information and/or channel state information for communication between a first device and a second device, and an adjusted first neural network model is sent, or a submodel in an adjusted first neural network model is sent, where the adjusted first neural network model is used for the communication between the first device and the second device. It can be learned that the neural network model used for the communication between the first device and the second device is obtained through adjustment based on the pre-trained neural network model that has been trained.

### CROSS-REFERENCE TO RELATED APPLICATIONS

This application is a continuation of International Application No. PCT/CN2023/086876, filed on Apr. 7, 2023, which claims priority to Chinese Patent Application No. 202210375312.5, filed on Apr. 11, 2022. The disclosures of the aforementioned applications are hereby incorporated by reference in their entireties.

### TECHNICAL FIELD

This application relates to the communication field, and in particular, to a communication method and a related apparatus.

### BACKGROUND

With continuous development of an artificial intelligence (artificial intelligence, AI) technology, the AI technology may be further applied to a network layer and a physical layer. For example, the AI technology may be used to implement network optimization, mobility management, resource allocation, and the like at the network layer, and may be further used to implement channel encoding/decoding, channel prediction, a receiver, and the like at the physical layer.

In a communication scenario, an AI model may be used to implement a communication transceiver to implement communication between a transmit end and a receive end. For example, the transmit end may process a to-be-sent signal by using a neural network model and send a signal, and the receive end may process the received signal by using the neural network model. A current AI transceiver can adapt only to a specific communication scenario. When the communication scenario changes, a corresponding model needs to be retrained, and it is difficult to perform deployment in a general-purpose communication system. How to determine or deploy the AI model used for the communication between the transmit end and the receive end is a problem to be urgently resolved.

### SUMMARY

Embodiments of this application provide a communication method and a related apparatus, to determine, with low complexity and low signaling overheads, a neural network model used for communication between a receive end and a transmit end.

According to a first aspect, an embodiment of this application provides a communication method. The method includes: determining a first neural network model from one or more pre-trained neural network models; adjusting the first neural network model based on first information, where the first information includes communication resource information and/or channel state information for communication between a first device and a second device; and sending an adjusted first neural network model, or sending a submodel in an adjusted first neural network model, where the adjusted first neural network model is used for the communication between the first device and the second device.

It can be learned that the neural network model used for the communication between the first device and the second device is obtained through adjustment based on the pre-trained neural network model that has been trained, and the obtained neural network model adapts to a scenario of the communication between the first device and the second device. Compared with a manner in which the first device and the second device retrain a neural network model for the communication, this manner can reduce complexity of determining the neural network model, and can further reduce signaling overheads of interaction between the first device and the second device for determining the neural network model.

In an optional implementation, the first neural network model is determined from the one or more pre-trained neural network models based on communication system parameters of the first device and/or communication system parameters of the second device, where the communication system parameters of the first device include a system bandwidth and a frame structure that are supported by the first device, and the communication system parameters of the second device include a system bandwidth and a frame structure that are supported by the second device. In this implementation, the determined first neural network model can adapt to a communication system including the first device and the second device. This helps improve performance of the adjusted first neural network model when being used for the communication between the first device and the second device, so that communication quality between the first device and the second device can be improved.

In an optional implementation, the first neural network model is determined based on a third neural network model selected from one or more second neural network models; and the one or more second neural network models are determined from the one or more pre-trained neural network models. An input dimension of each of the one or more second neural network models is the same as a first input dimension corresponding to each second neural network model, and/or an output dimension of each second neural network model is the same as a first output dimension corresponding to each second neural network model; and the first input dimension and/or the first output dimension corresponding to each second neural network model are/is determined based on a size that is of a resource patch (resource patch, RP) and that is applicable to the second neural network model, and the communication system parameters of the first device and/or the communication system parameters of the second device.

In this implementation, an input dimension of the first neural network model may be the same as a first input dimension corresponding to the first neural network model, and/or an output dimension of the first neural network model may be the same as a first output dimension corresponding to the first neural network model, so that the first neural network model can adapt to the scenario of the communication between the first device and the second device.

Optionally, the size of the RP is determined based on a time domain length of the RP and a frequency domain width of the RP.

In an optional implementation, the second neural network model supports a first service type; and the first service type is a service type needed by the first device and the second device. In this implementation, the one or more second neural network models are selected from the pre-trained neural networks based on the service type, so that the first neural network model determined from the one or more neural network models supports the service type needed by the first device and the second device.

In an optional implementation, if there are a plurality of second neural network models, the third neural network model is a second neural network model with a largest parameter amount in the plurality of second neural network models. Usually, a larger parameter amount of the neural network model indicates better performance. In this implementation, the determined third neural network model may be a second neural network model with best performance in the plurality of second neural network models.

Alternatively, the third neural network model is a second neural network model with a smallest absolute difference between an operation amount and a first operation amount in a plurality of second neural network models, where the first operation amount is determined based on a computing power and a latency requirement of the first device and/or a computing power and a latency requirement of the second device. In this implementation, an operation amount of the third neural network model determined from the plurality of second neural network models may be closest to a maximum range supported by operation capabilities of the first device and the second device.

Alternatively, the third neural network model is a second neural network model with a smallest absolute difference between a parameter amount and a first parameter amount in the plurality of second neural network models, where the first parameter amount is determined based on a computing power and storage space of the first device, and/or a computing power and storage space of the second device. In this implementation, a parameter amount of the third neural network model determined from the plurality of second neural network models may be closest to a maximum range supported by storage capabilities of the first device and the second device.

In an optional implementation, the first neural network model is obtained by performing distillation on the third neural network model; and an operation amount of the third neural network model is greater than a first operation amount, and/or a parameter amount of the third neural network model is greater than a first parameter amount, where the first operation amount is determined based on a computing power and a latency requirement of the first device and/or a computing power and a latency requirement of the second device; and the first parameter amount is determined based on the computing power and storage space of the first device and/or the computing power and storage space of the second device. In this implementation, the first neural network model may be obtained by reducing the parameter amount and/or the operation amount of the third neural network model. In this way, an operation amount of the first neural network model falls within a range supported by the operation capabilities of the first device and the second device, and a parameter amount falls within a range supported by the storage capabilities of the first device and the second device.

In an optional implementation, the first neural network model is the third neural network model; and an operation amount of the third neural network model is less than or equal to a first operation amount, and/or a parameter amount of the third neural network model is less than or equal to a first parameter amount, where the first operation amount is determined based on a computing power and a latency requirement of the first device and/or a computing power and a latency requirement of the second device; and the first parameter amount is determined based on the computing power and storage space of the first device and/or the computing power and storage space of the second device. It can be learned that in this implementation, if the operation amount and the parameter amount of the third neural network model respectively fall within the ranges supported by the operation capabilities and the storage capabilities of the first device and the second device, the third neural network model may be directly used as the first neural network model.

In an optional implementation, the first neural network model is determined by a model server based on received model request information; and the model request information includes an identifier of the third neural network model, and a first operation amount and/or a first parameter amount, where the first operation amount is determined based on a computing power and a latency requirement of the first device and/or a computing power and a latency requirement of the second device, and the first parameter amount is determined based on the computing power and storage space of the first device and/or the computing power and storage space of the second device. It can be learned that this implementation may be applied to a case in which the first neural network model may be obtained from the model server when the model server stores the one or more pre-trained neural network models.

Optionally, information about each of the one or more pre-trained neural network models is predefined, or is obtained from the model server; and the information about each pre-trained neural network model includes one or more of the following: an identifier, a service type, a size of an RP, an input dimension, an output dimension, a parameter amount, and an operation amount.

In an optional implementation, the adjusted first neural network model is obtained by training a fourth neural network model based on the channel state information in the first information; and the fourth neural network model is obtained by adjusting an input dimension and/or an output dimension of the first neural network model based on a size that is of an RP and that is applicable to the first neural network model and the communication resource information in the first information. In this implementation, the first neural network model is adjusted based on the communication resource information and the channel state information that are used for the communication between the first device and the second device, so that the adjusted first neural network model can adapt to the scenario of the communication between the first device and the second device.

According to a second aspect, an embodiment of this application provides a communication method. The method includes: receiving an adjusted first neural network model, or receiving a submodel in an adjusted first neural network model, where the adjusted first neural network model is used for communication between a first device and a second device; and the adjusted first neural network model is obtained by adjusting a first neural network model based on first information, and the first information includes communication resource information and/or channel state information for the communication between the first device and the second device; and the first neural network model is determined from one or more pre-trained neural network models; and performing communication based on the adjusted first neural network model, or performing communication based on the submodel in the adjusted first neural network model.

It can be learned that the neural network model used for the communication between the first device and the second device is obtained through adjustment based on the pre-trained neural network model that has been trained, and the determined neural network model adapts to a scenario of the communication between the first device and the second device. Compared with a manner in which the first device and the second device retrain a neural network model for the communication, this manner can reduce complexity of determining the neural network model, and can further reduce signaling overheads of interaction between the devices for determining the neural network model.

In an optional implementation, the first neural network model is determined from the one or more pre-trained neural network models based on communication system parameters of the first device and/or communication system parameters of the second device, where the communication system parameters of the first device include a system bandwidth and a frame structure that are supported by the first device, and the communication system parameters of the second device include a system bandwidth and a frame structure that are supported by the second device. In this implementation, the determined first neural network model adapts to the scenario of the communication between the first device and the second device. This helps improve performance of the adjusted first neural network model when being used for the communication between the first device and the second device, so that communication quality between the first device and the second device can be improved.

Optionally, the method further includes: sending communication system parameters.

In an optional implementation, the first neural network model is determined based on a third neural network model selected from one or more second neural network models; and the one or more second neural network models are determined from the one or more pre-trained neural network models. An input dimension of each of the one or more second neural network models is the same as a first input dimension corresponding to each second neural network model, and/or an output dimension of each second neural network model is the same as a first output dimension corresponding to each second neural network model; and the first input dimension and/or the first output dimension corresponding to each second neural network model are/is determined based on a size that is of a resource patch RP and that is applicable to the second neural network model, and the communication system parameters of the first device and/or the communication system parameters of the second device.

In this implementation, an input dimension of the first neural network model may be the same as a first input dimension corresponding to the first neural network model, and/or an output dimension of the first neural network model may be the same as a first output dimension corresponding to the first neural network model, so that the first neural network model can adapt to the scenario of the communication between the first device and the second device.

Optionally, the size of the RP is determined based on a time domain length of the RP and a frequency domain width of the RP.

In an optional implementation, the second neural network model supports a first service type; and the first service type is a service type needed by the first device and the second device. In this implementation, the one or more second neural network models are selected from the pre-trained neural networks based on the service type, so that the first neural network model determined from the one or more neural network models supports the service type needed by the first device and the second device.

Optionally, the method further includes: sending a needed service type.

In an optional implementation, if there are a plurality of second neural network models, the third neural network model is a neural network model with a largest parameter amount in the plurality of second neural network models. Usually, a larger parameter amount of the neural network model indicates better performance. In this implementation, the determined third neural network model may be a second neural network model with best performance in the plurality of second neural network models.

Alternatively, the third neural network model is a neural network model with a smallest absolute difference between an operation amount and a first operation amount in a plurality of second neural network models, where the first operation amount is determined based on a computing power and a latency requirement of the first device and/or a computing power and a latency requirement of the second device. In this implementation, an operation amount of the third neural network model determined from the plurality of second neural network models may be closest to a maximum range supported by operation capabilities of the first device and the second device.

Alternatively, the third neural network model is a neural network model with a smallest absolute difference between a parameter amount and a first parameter amount in the plurality of second neural network models, where the first parameter amount is determined based on a computing power and storage space of the first device, and/or a computing power and storage space of the second device. In this implementation, a parameter amount of the third neural network model determined from the plurality of second neural network models may be closest to a maximum range supported by storage capabilities of the first device and the second device.

Optionally, the method further includes: sending a computing power and a latency requirement, or sending a computing power and storage space, or sending a computing power, a latency requirement, and storage space.

In an optional implementation, the first neural network model is obtained by performing distillation on the third neural network model; and an operation amount of the third neural network model is greater than a first operation amount, and/or a parameter amount of the third neural network model is greater than a first parameter amount. The first operation amount is determined based on a computing power and a latency requirement of the first device and/or a computing power and a latency requirement of the second device; and the first parameter amount is determined based on the computing power and storage space of the first device and/or the computing power and storage space of the second device. In this implementation, the first neural network model may be obtained by reducing the parameter amount and/or the operation amount of the third neural network model. In this way, a parameter amount and an operation amount of the first neural network model fall within ranges supported by the operation capabilities and the storage capabilities of the first device and the second device.

In an optional implementation, the first neural network model is the third neural network model; and an operation amount of the third neural network model is less than or equal to a first operation amount, and/or a parameter amount of the third neural network model is less than or equal to a first parameter amount, where the first operation amount is determined based on a computing power and a latency requirement of the first device and/or a computing power and a latency requirement of the second device; and the first parameter amount is determined based on the computing power and storage space of the first device and/or the computing power and storage space of the second device. It can be learned that in this implementation, if the parameter amount and the operation amount of the third neural network model fall within the ranges supported by the operation capabilities and the storage capabilities of the first device and the second device, the third neural network model may be directly used as the first neural network model.

In an optional implementation, the first neural network model is determined by a model server based on received model request information; and the model request information includes an identifier of the third neural network model, and a first operation amount and/or a first parameter amount, where the first operation amount is determined based on a computing power and a latency requirement of the first device and/or a computing power and a latency requirement of the second device, and the first parameter amount is determined based on the computing power and storage space of the first device and/or the computing power and storage space of the second device. Optionally, information about each of the one or more pre-trained neural network models is predefined, or is obtained from the model server; and the information about each pre-trained neural network model includes one or more of the following: an identifier, a service type, a size of an RP, an input dimension, an output dimension, a parameter amount, and an operation amount.

In an optional implementation, the adjusted first neural network model is obtained by training a fourth neural network model based on the channel state information in the first information; and the fourth neural network model is obtained by adjusting an input dimension and/or an output dimension of the first neural network model based on a size that is of an RP and that is applicable to the first neural network model and the communication resource information in the first information. In this implementation, the first neural network model may be adjusted based on the communication resource information and/or the channel state information that are used for the communication between the two devices, so that the adjusted first neural network model can adapt to the scenario of the communication between the first device and the second device.

According to a third aspect, this application further provides a communication apparatus. The communication apparatus has a function of implementing some or all of the implementations of the first aspect, or has a function of implementing some or all of the implementations of the second aspect. The function may be implemented by hardware, or may be implemented by hardware executing corresponding software. The hardware or the software includes one or more units or modules corresponding to the function.

In a possible design, a structure of the communication apparatus may include a processing unit and a communication unit. The processing unit is configured to support the communication apparatus in performing a corresponding function in the foregoing method. The communication unit is configured to support communication between the communication apparatus and another communication apparatus. The communication apparatus may further include a storage unit. The storage unit is configured to: be coupled to the processing unit and the communication unit, and store program instructions and data that are necessary for the communication apparatus.

In an implementation, the communication apparatus includes a processing unit and a communication unit. The processing unit is configured to control the communication unit to receive and send data/signaling.

The processing unit is configured to determine a first neural network model from one or more pre-trained neural network models. The processing unit is further configured to adjust the first neural network model based on first information. The first information includes communication resource information and/or channel state information for communication between a first device and a second device. The communication unit is configured to: send an adjusted first neural network model, or send a submodel in an adjusted first neural network model. The adjusted first neural network model is used for the communication between the first device and the second device.

In addition, for another optional implementation of the communication apparatus in this aspect, refer to related content of the first aspect. Details are not described herein again.

In another implementation, the communication apparatus includes a processing unit and a communication unit. The processing unit is configured to control the communication unit to receive and send data/signaling.

The communication unit is configured to: receive an adjusted first neural network model, or receive a submodel in an adjusted first neural network model, where the adjusted first neural network model is used for communication between a first device and a second device; and the adjusted first neural network model is obtained by adjusting a first neural network model based on first information, and the first information includes communication resource information and/or channel state information for the communication between the first device and the second device. The communication unit is further configured to: perform communication based on the adjusted first neural network model, or perform communication based on the submodel in the adjusted first neural network model.

In addition, for another optional implementation of the communication apparatus in this aspect, refer to related content of the second aspect. Details are not described herein again.

In an example, the communication unit may be a transceiver or a communication interface, the storage unit may be a memory, and the processing unit may be a processor.

In an implementation, the communication apparatus includes a processor and a transceiver. The processor is configured to determine a first neural network model from one or more pre-trained neural network models. The processor is further configured to adjust the first neural network model based on first information. The first information includes communication resource information and/or channel state information for communication between a first device and a second device. The transceiver is configured to: send an adjusted first neural network model, or send a submodel in an adjusted first neural network model. The adjusted first neural network model is used for the communication between the first device and the second device.

In addition, for another optional implementation of the communication apparatus in this aspect, refer to related content of the first aspect. Details are not described herein again.

In another implementation, the communication apparatus includes a transceiver. The transceiver is configured to: receive an adjusted first neural network model, or receive a submodel in an adjusted first neural network model, where the adjusted first neural network model is used for communication between a first device and a second device; and the adjusted first neural network model is obtained by adjusting a first neural network model based on first information, and the first information includes communication resource information and/or channel state information for the communication between the first device and the second device; and the first neural network model is determined from one or more pre-trained neural network models. The transceiver is further configured to: perform communication based on the adjusted first neural network model, or perform communication based on the submodel in the adjusted first neural network model.

In addition, for another optional implementation of the communication apparatus in this aspect, refer to related content of the second aspect. Details are not described herein again.

In another implementation, the communication apparatus is a chip or a chip system. The processing unit may also be embodied as a processing circuit or a logic circuit. The transceiver unit may be an input/output interface, an interface circuit, an output circuit, an input circuit, a pin, a related circuit, or the like on the chip or the chip system.

In an implementation process, the processor may be configured to perform, for example, but not limited to, baseband related processing; and the transceiver may be configured to perform, for example, but not limited to, radio frequency receiving and sending. The foregoing devices may be separately disposed on chips that are independent of each other, or at least some or all of the devices may be disposed on a same chip. For example, the processor may be further divided into an analog baseband processor and a digital baseband processor. The analog baseband processor and the transceiver may be integrated on a same chip, and the digital baseband processor may be disposed on an independent chip. With continuous development of integrated circuit technologies, an increasing quantity of devices may be integrated to a same chip. For example, the digital baseband processor and a plurality of application processors (for example, but not limited to, a graphics processing unit and a multimedia processor) may be integrated on a same chip. Such a chip may be referred to as a system-on-a-chip (System-on-a-Chip, SoC). Whether the devices are separately disposed on different chips or integrated and disposed on one or more chips usually depends on a requirement of a product design. This embodiment of this application imposes no limitation on implementations of the foregoing devices.

According to a fourth aspect, this application further provides a processor, configured to perform the foregoing methods. In a process of performing these methods, a process of sending the foregoing information and a process of receiving the foregoing information in the foregoing methods may be understood as a process of outputting the foregoing information by the processor and a process of inputting the foregoing information by the processor. When outputting the information, the processor outputs the information to a transceiver, so that the transceiver transmits the information. After the information is outputted by the processor, other processing may further need to be performed on the information before the information arrives at the transceiver. Similarly, when receiving of the input information by the processor, the transceiver receives the information, and inputs the information to the processor. Further, after the transceiver receives the foregoing information, other processing may need to be performed on the information before the information is input into the processor.

Unless otherwise specified, operations such as sending and receiving related to the processor may be more usually understood as operations such as outputting, receiving, and inputting of the processor if the operations do not conflict with actual functions or internal logic of the operations in related descriptions, instead of operations such as sending and receiving directly performed by a radio frequency circuit and an antenna.

In an implementation process, the processor may be a processor specially configured to perform these methods, or may be a processor, for example, a general-purpose processor, that executes computer instructions in the memory to perform these methods. The memory may be a non-transitory (non-transitory) memory, for example, a read-only memory (Read-Only Memory, ROM). The memory and the processor may be integrated on a same chip, or may be separately disposed on different chips. A type of the memory and a manner of disposing the memory and the processor are not limited in embodiments of this application.

According to a fifth aspect, this application further provides a communication system. The system includes at least one first device and at least one second device in the foregoing aspects. In another possible design, the system may further include another device that interacts with the first device and the second device in the solutions provided in this application.

According to a sixth aspect, this application provides a computer-readable storage medium, configured to store instructions. When the instructions are run by a computer, the method according to the first aspect or the second aspect is implemented.

According to a seventh aspect, this application further provides a computer program product including instructions. When the computer program product runs on a computer, the method according to the first aspect or the second aspect is implemented.

According to an eighth aspect, this application provides a chip system. The chip system includes a processor and an interface, the interface is configured to obtain a program or instructions, and the processor is configured to invoke the program or the instructions to implement a function in the first aspect, or is configured to invoke the program or the instructions to implement a function in the second aspect. In a possible design, the chip system further includes a memory. The memory is configured to store program instructions and data that are necessary for a terminal. The chip system may include a chip, or may include a chip and another discrete device.

### BRIEF DESCRIPTION OF DRAWINGS

FIG. 1 is a diagram of a structure of a communication system according to an embodiment of this application;

FIG. 2 is a diagram of a structure of another communication system according to an embodiment of this application;

FIG. 3a is a diagram of a structure of a full-connection neural network according to an embodiment of this application;

FIG. 3b is a diagram of a manner of training a neural network according to an embodiment of this application;

FIG. 3c is a diagram of gradient reverse transmission according to an embodiment of this application;

FIG. 4 is an interaction diagram of a communication method according to an embodiment of this application;

FIG. 5 is a diagram of resource division according to an embodiment of this application;

FIG. 6a is a diagram of model adjustment according to an embodiment of this application;

FIG. 6b is a diagram of another model adjustment according to an embodiment of this application;

FIG. 6c is a diagram of still another model adjustment according to an embodiment of this application;

FIG. 7A and FIG. 7B are an interaction diagram of another communication method according to an embodiment of this application;

FIG. 8a is a diagram of uplink communication or downlink communication according to an embodiment of this application;

FIG. 8b is a diagram of D2D communication according to an embodiment of this application;

FIG. 9 is a diagram of a protocol stack according to an embodiment of this application;

FIG. 10 is a diagram of a structure of a communication apparatus according to an embodiment of this application;

FIG. 11 is a diagram of a structure of another communication apparatus according to an embodiment of this application; and

FIG. 12 is a diagram of a structure of a chip according to an embodiment of this application.

### DESCRIPTION OF EMBODIMENTS

The following clearly and completely describes the technical solutions in embodiments of this application with reference to the accompanying drawings in embodiments of this application.

To better understand a communication method disclosed in embodiments of this application, a communication system to which embodiments of this application are applicable is described.

Embodiments of this application may be applied to a 4th generation (4th generation, 4G) communication system like a long term evolution (long term evolution, LTE) system, or a 5th generation (5th generation, 5G) communication system such as a new radio (new radio, NR) system, and may be further applied to a short-range communication system such as a wireless fidelity (wireless fidelity, Wi-Fi) system, a communication system that supports convergence of a plurality of wireless technologies, or a communication system that is evolved after 5G like a 6th generation (6th generation, 6G) communication system. In embodiments of this application, a wireless communication system includes but is not limited to three major application scenarios of a narrowband internet of things (narrowband internet of things, NB-IoT) system, the LTE system, and the 5G mobile communication system: enhanced mobile broadband (enhanced mobile broadband, eMBB), ultra-reliable low-latency communication (ultra-reliable low-latency communication, URLLC), and massive machine-type communications (massive machine-type communications, mMTC).

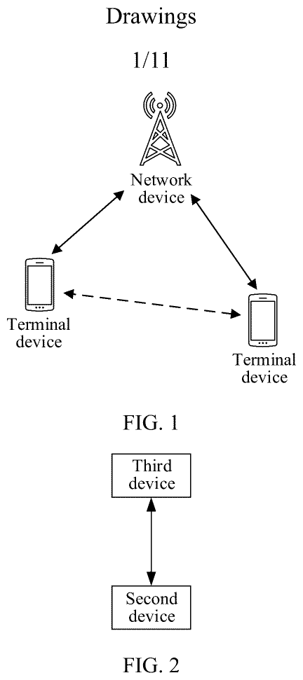

An architecture of a wireless communication system is shown in FIG. 1. The wireless communication system may include one or more network devices and one or more terminal devices. The network device and the terminal device may communicate with each other, and different terminal devices may also communicate with each other. In FIG. 1, an example in which the wireless communication system includes one network device and two terminal devices is used.

FIG. 2 is a diagram of a structure of another communication system according to an embodiment of this application. The communication system includes but is not limited to one third device and one second device. A quantity and forms of devices shown in FIG. 2 are used as an example and do not constitute a limitation on embodiments of this application. In actual application, two or more third devices and two or more second devices may be included, or a first device may be included. The third device may be a network device or a terminal device. Alternatively, the second device may be a network device or a terminal device, and the first device may be a network device or a terminal device.

In embodiments of this application, the network device is a device having a wireless transceiver function, and may be an evolved NodeB (evolved NodeB, eNB or eNodeB) in LTE, a base station in a 5G network, a base station in a future evolved public land mobile network (public land mobile network, PLMN), a broadband network gateway (broadband network gateway, BNG), an aggregation switch, a non-3rd generation partnership project (3rd generation partnership project, 3GPP) access device, or the like. Optionally, the network device in embodiments of this application may include various forms of base stations, for example, a macro base station, a micro base station (also referred to as a small cell), a relay station, an access point, a device that implements a base station function in a communication system evolved after 5G, an access node in a Wi-Fi system, a transmission reception point (transmission reception point, TRP), a transmitting point (transmitting point, TP), a mobile switching center, and a device that undertakes the base station function in device-to-device (D2D), vehicle-to-everything (vehicle-to-everything, V2X), and machine-to-machine (M2M) communication; and may further include a central unit (central unit, CU) and a distributed unit (distributed unit, DU) in a cloud access network (cloud radio access network, C-RAN) system, and a network device in a non-terrestrial network (non-terrestrial network, NTN) communication system, that is, may be deployed on a high-altitude platform or a satellite. This is not specifically limited in embodiments of this application.

The terminal device may include various handheld devices, vehicle-mounted devices, wearable devices, or computing devices that have a wireless communication function, or other processing devices connected to a wireless modem. The terminal device may alternatively be user equipment (user equipment, UE), an access terminal, customer-premises equipment (customer-premises equipment, CPE), a subscriber unit (subscriber unit), a user agent, a cellular phone (cellular phone), a smartphone (smartphone), a wireless data card, a personal digital assistant (personal digital assistant, PDA) computer, a tablet computer, a wireless modem (modem), a handheld device (handset), a laptop computer (laptop computer), a machine type communication (machine type communication, MTC) terminal, a communication device carried on a high-altitude aircraft, a wearable device, an uncrewed aerial vehicle, a robot, a smart point of sale (point of sale, POS) machine, a terminal in D2D, a terminal in V2X, a virtual reality (virtual reality, VR) terminal device, an augmented reality (augmented reality, AR) terminal device, a wireless terminal in industrial control (industrial control), a wireless terminal in self driving (self driving), a wireless terminal in telemedicine (remote medical), a wireless terminal in a smart grid (smart grid), a wireless terminal in transportation safety (transportation safety), a wireless terminal in a smart city (smart city), a wireless terminal in a smart home (smart home), a terminal device in a communication network evolved after 5G, or the like. This is not limited in this application.

In embodiments disclosed in this application, all aspects, embodiments, or features of this application are presented by describing a system including a plurality of devices, components, modules, and the like. It should be understood and appreciated that, each system may include another device, component, module, and the like, and/or may not include all devices, components, modules, and the like discussed with reference to the accompanying drawings. In addition, a combination of these solutions may be used.

To better understand the communication method disclosed in embodiments of this application, related concepts in embodiments of this application are briefly described.

### 1. Fully-Connected Neural Network

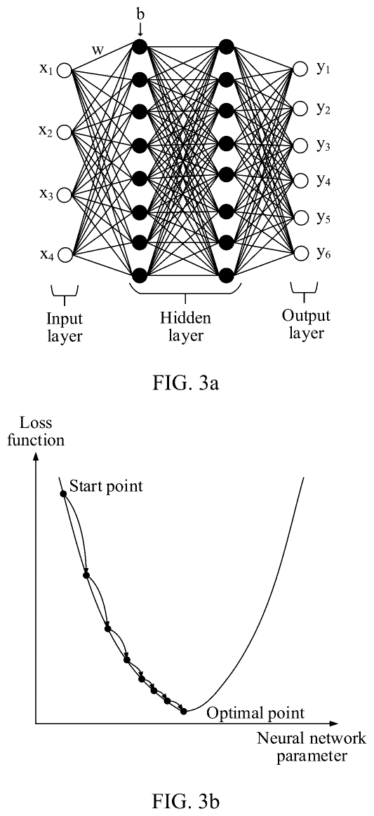

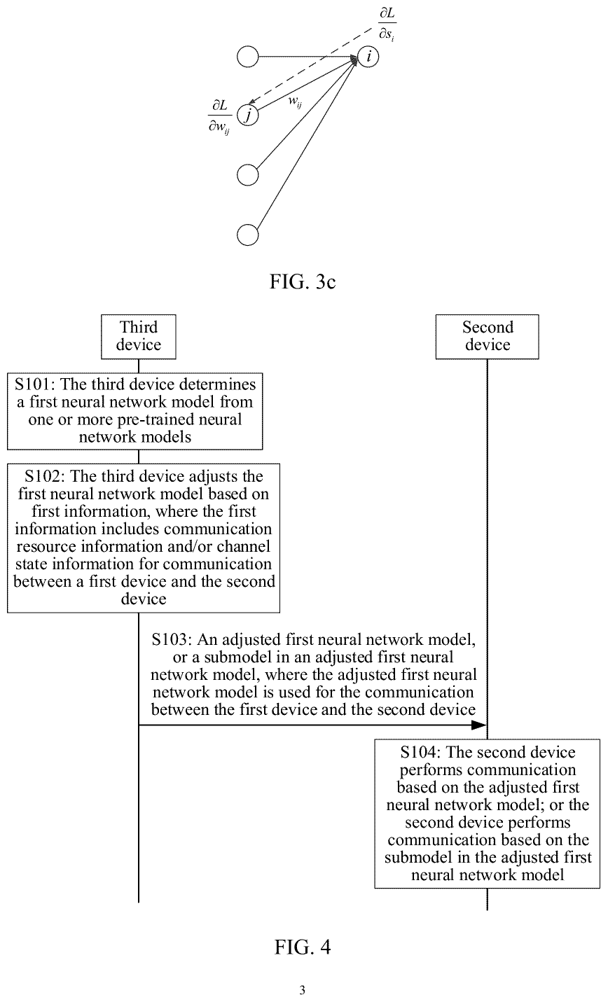

A fully connected neural network may also be referred to as a multi-layer perceptron (multi-layer perceptron, MLP). One MLP includes one input layer, one output layer, and a plurality of hidden layers, and each layer includes several nodes. The nodes may be referred to as neurons. Neurons at two adjacent layers are connected to each other. For example, an MLP shown in FIG. 3a includes one input layer, one output layer, and two hidden layers. The input layer includes four neurons, each hidden layer includes eight neurons, and the output layer includes six neurons.

For neurons at two adjacent layers, an output h of a neuron at a lower layer is obtained by processing, by using an activation function, a weighted sum of all neurons x at an upper layer that are connected to the neuron. A matrix may be expressed as:

$$h = f ( w x + b ) \qquad ( 1 )$$

w is a weight matrix, b is a bias vector, and f( ) is the activation function.

In this case, an output of the neural network may be recursively expressed as:

$$y = {f}_{n} ( {w}_{n} {f}_{n - 1} ( … ) + {b}_{n} ) \qquad ( 2 )$$

It can be learned that the neural network may represent a mapping relationship from an input data set to an output data set. The neural network is usually randomly initialized, and needs to be put into use after being trained. The training of the neural network is a process of determining the mapping relationship from random w and b and by using existing data.

With reference to FIG. 3b, a specific manner of training the neural network includes: evaluating an output result of the neural network by using a loss function (loss function), backpropagating an error, and iteratively optimizing w and b by using a gradient descent method until the loss function reaches a smallest value. A gradient descent process may be represented as:

$$θ ← θ - η \frac{\partial L}{\partial θ} \qquad ( 3 )$$

θ is to-be-optimized parameters (for example, w and b), and Z is the loss function; and n is learning efficiency, and is used to control a gradient descent step.

In addition, a chain rule for obtaining a partial derivative is used in a backpropagation process, to be specific, a gradient of a parameter of a former layer may be recursively calculated based on a gradient of a parameter of a latter layer. For example, a gradient of a weight wᵢⱼ between a neuron j and a neuron i in FIG. 3c may be represented as:

$$\frac{\partial L}{\partial {w}_{i j}} = \frac{\partial L}{\partial {s}_{i}} \frac{\partial {s}_{i}}{\partial {w}_{i j}} \qquad ( 4 )$$

sᵢ is an input weighted sum on the neuron i. In addition, in Formula (4),

$$\frac{\partial L}{\partial {s}_{i}}$$

may be referred to as an intermediate layer gradient, that is, s; is considered as an intermediate layer.

### 2. Large Model

A large model is a neural network model having a huge parameter amount and pre-trained by using a large amount of data, for example, a full-connection neural network model having a large parameter amount. The large model has strong information extraction and expression capabilities, and can be used to complete a plurality of types of tasks. For example, a large model in a field of natural language processing is a generative pre-trained transformer 3 (Generative Pre-trained Transformer 3, GPT-3), and includes a parameter amount 175 billion, and the GPT-3 may be used to complete various tasks related to the natural language processing, such as translation, article writing, and searching.

An embodiment of this application provides a communication method. In the communication method, a first neural network model may be determined from one or more pre-trained neural network models, and the first neural network model is adjusted based on communication resource information and/or channel state information for communication between a first device and a second device, where an adjusted first neural network model may be used for the communication between the first device and the second device. In the method, the neural network model used for the communication between the first device and the second device can be determined with low complexity and low signaling overheads.

The following describes, with reference to the accompanying drawings, the communication method provided in embodiments of this application.

FIG. 4 is an interaction diagram of a communication method according to an embodiment of this application. The communication method is described from a perspective of interaction between a third device and a second device. The communication method includes the following steps.

S101: The third device determines a first neural network model from one or more pre-trained neural network models. The one or more pre-trained neural network models may be one or more large models that have been trained.

In an optional implementation, the first neural network model is determined from the one or more pre-trained neural network models based on communication system parameters of a first device and/or communication system parameters of the second device, where the communication system parameters of the first device include a system bandwidth and a frame structure that are supported by the first device, and the communication system parameters of the second device include a system bandwidth and a frame structure that are supported by the second device.

Optionally, the communication system parameters may further include a carrier frequency, a system parameter (numerology), an antenna configuration, a reference signal location, and the like. The system parameter may include a subcarrier spacing, a length of each slot (slot), a quantity of symbols (symbols) included in each slot, a length of a cyclic prefix (cyclic prefix, CP) in each symbol, and the like. The antenna configuration may include a quantity of antenna ports, and the reference signal location may include a time domain resource location, a frequency domain resource location, a space domain resource location, and the like in which a reference signal is located. In other words, the communication system parameters of the first device represent resources on which the first device can operate, and the communication system parameters of the first device are related parameters of the resources on which the first device can operate. The communication system parameters of the second device represent resources on which the second device can operate, and the communication system parameters of the second device are related parameters of the resources on which the second device can operate.

In addition, the first neural network model determined in step S101 is used to determine a neural network model used for communication between the first device and the second device. The first device may be a third device, or may be another device different from the second device and the third device. When the first device is the another device different from the second device and the third device, the first device may be another network device or terminal device.

Optionally, the communication system parameters of the first device and/or the communication system parameters of the second device may be communication system parameters determined by the third device from a plurality of groups of predefined communication system parameters. A group of communication system parameters determined for the first device is applicable to the first device, and a group of communication system parameters determined for the second device is applicable to the second device. Alternatively, the communication system parameters of the second device may be sent by the second device to the third device. If the first device is the another device different from the second device and the third device, the communication system parameters of the first device may be sent by the first device to the third device.

Optionally, the first neural network model is determined based on a third neural network model selected from one or more second neural network models; and the one or more second neural network models are determined from the one or more pre-trained neural network models. An input dimension of each of the one or more second neural network models is the same as a first input dimension corresponding to each second neural network model, and/or an output dimension of each second neural network model is the same as a first output dimension corresponding to each second neural network model. The first input dimension and/or the first output dimension corresponding to each second neural network model are/is determined based on a size that is of a resource patch (resource patch, RP) and that is applicable to the second neural network model, and the communication system parameters of the first device and/or the communication system parameters of the second device. In this implementation, the determined first neural network model can adapt to a communication system including the first device and the second device. This helps improve performance of the adjusted first neural network model when being used for the communication between the first device and the second device, so that communication quality between the first device and the second device can be improved. In addition, in this embodiment of this application, the RP may also be referred to as a resource package.

Optionally, if values of the communication system parameters of the first device are different from those of the communication system parameters of the second device, a first input dimension and/or a first output dimension corresponding to each of the one or more pre-trained neural network models may be determined based on a size that is of an RP and that is applicable to the pre-trained neural network model, and the communication system parameters with smallest values in the communication system parameters of the first device and the communication system parameters of the second device. For example, the communication system parameters include the system bandwidth, the frame structure, and the quantity of antenna ports. If values of frame lengths corresponding to the frame structures respectively supported by the first device and the second device are the same, values of the system bandwidths are different, and values of the quantities of antenna ports are different, a first input dimension and/or a first output dimension corresponding to a pre-trained neural network model may be determined based on the frame length with the same value, the system bandwidth with a smallest value, a quantity of antenna ports with a smallest value, and a size that is of an RP and that is applicable to the pre-trained neural network model.

For example, the first device is a device 1, and the second device is a device 2, where a frame length corresponding to a frame structure supported by the device 1 is the same as a frame length corresponding to a frame structure supported by the device 2, and both are a frame length 1; and a system bandwidth 1 supported by the device 1 is less than a system bandwidth 2 supported by the device 2, and a quantity 1 of antenna ports supported by the device 1 is greater than a quantity 2 of antenna ports supported by the device 2. In this case, a first input dimension and/or a first output dimension corresponding to a pre-trained neural network model may be determined based on a size that is of an RP and that is applicable to the pre-trained neural network model, the frame length 1, the system bandwidth 1, and the quantity 2 of antenna ports.

Optionally, a size that is of an RP and that is applicable to each pre-trained neural network model may be determined based on a time domain length of the RP and a frequency domain width of the RP that are applicable to the pre-trained neural network model; or may be determined based on a time domain length of the RP, a frequency domain width of the RP, a space domain width of the RP, and the like that are applicable to the pre-trained neural network model. In addition, sizes that are of RPs and that are applicable to different pre-trained neural network models may be different. A unit of the time domain length of the RP is, for example, millisecond (millisecond, ms), a unit of the frequency domain width of the RP is, for example, kilohertz (kilohertz, kHz), the space domain width of the RP may be represented as a quantity of spatial flows occupied by the RP, and a unit of the space domain width of the RP is, for example, a flow.

An example in which the communication system parameters include the system bandwidth and the frame structure is used. A first input dimension or a first output dimension corresponding to each pre-trained neural network model is equal to

$$ceil ( \frac{{B}_{sys}}{{B}_{r p}} ) \times ceil ( \frac{{S}_{sys}}{{S}_{rp}} ) .$$

If the communication system parameters further include the quantity of antenna ports, a first input dimension or a first output dimension corresponding to each pre-trained neural network model is equal to

$$ceil ( \frac{{B}_{sys}}{{B}_{r p}} ) \times ceil ( \frac{{S}_{sys}}{{S}_{rp}} ) \times n .$$

B_{sys} is the system bandwidth with a smallest value in the system bandwidth supported by the first device and the system bandwidth supported by the second device, S_{sys} is the frame length with a smallest value in the frame lengths corresponding to the frame structures respectively supported by the first device and the second device, and n is the quantity of antenna ports with a smallest value in the quantity of antenna ports supported by the first device and the quantity of antenna ports supported by the second device. Especially, if the system bandwidth supported by the first device is the same as the system bandwidth supported by the second device, B_{sys} is a value of the same system bandwidth; if the frame length corresponding to the frame structure supported by the first device is the same as the frame length corresponding to the frame structure supported by the second device, S_{sys} is a value of the same frame length; and if the quantity of antenna ports supported by the first device is the same as the quantity of antenna ports supported by the second device, n is a value of the same quantity of antenna ports. In addition, Bᵣₚ is the frequency domain width that is of the RP and that is applicable to the pre-trained neural network model, Sᵣₚ is the time domain length that is of the RP and that is applicable to the pre-trained neural network model, and ceil( ) is a rounding-up function.

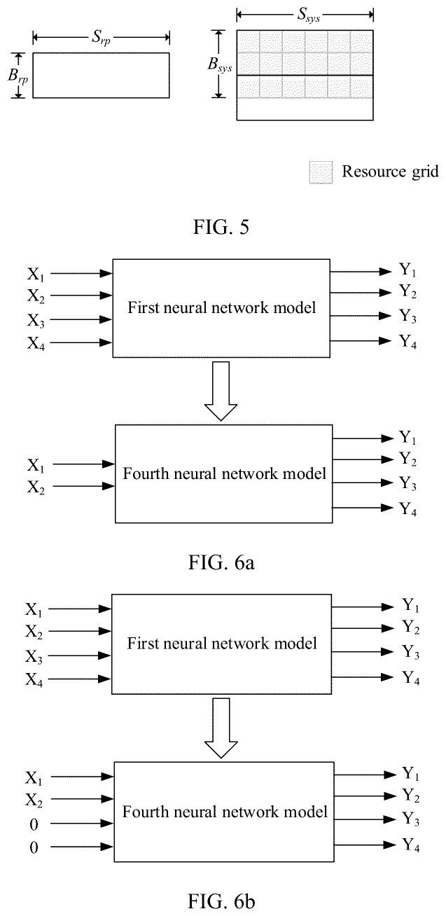

For example, with reference to FIG. 5, a resource grid shown in FIG. 5 is a resource grid on one antenna port. As shown in FIG. 5,

$$ceil ( \frac{{B}_{sys}}{{B}_{rp}} ) = 2 , and ceil ( \frac{{S}_{sys}}{{S}_{rp}} ) = 1.$$

If the quantity n of antenna ports is 1, it indicates that a resource grid that is of the antenna port and on which the first device and the second device operate may be divided into two RPs, and the RPs are RPs applicable to a pre-trained neural network model. In this case, a first input dimension or a first output dimension corresponding to the pre-trained neural network model may be determined as 2. Alternatively, if the quantity n of antenna ports is 2, it indicates that resource grids that are of the two antenna ports and on which the first device and the second device operate may be divided into four RPs in total. In this case, a first input dimension or a first output dimension corresponding to the pre-trained neural network model may be determined as 4.

Especially, usually, values of communication system parameters of a network device are greater than values of communication system parameters of a terminal device. For example, a system bandwidth supported by the network device is greater than a system bandwidth supported by the terminal device, and a frame length corresponding to a frame structure supported by the network device is greater than a frame length corresponding to a frame structure supported by the terminal device. In this case, if one of the first device and the second device is a network device, and the other device is a terminal device, the first neural network model is determined from the one or more pre-trained neural network models based on communication system parameters of the terminal device in the first device and the second device. In this case, B_{sys} in the foregoing formula is a system bandwidth supported by the terminal device in the first device and the second device, S_{sys} is a frame length corresponding to a frame structure supported by the terminal device in the first device and the second device, and n is a quantity of antenna ports supported by the terminal device in the first device and the second device.

Optionally, the second neural network model supports a first service type; and the first service type is a service type needed by the first device and the second device. This manner helps enable the determined first neural network model to support the service type needed by the first device and the second device. Optionally, the first service type may be determined based on service information of the first device and service information of the second device. The service information of either the first device or the second device may include one of service types such as eMBB, URLLC, and mMTC that is needed by the device; or the service information of either device may include requirements of the device on performance indicators such as a communication latency and a throughput of the neural network model, which reflects a performance requirement of the device. The communication latency of the neural network model includes time for a transmit end to process a to-be-sent signal based on the neural network model, time for transmission of a processed signal, and time for a receive end to process the received signal based on the neural network model, and a unit of the communication latency is, for example, ms. The throughput of the neural network model refers to an amount of data sent and/or received based on the neural network model within a specific period of time, and a unit of the throughput is, for example, megabits per second (megabits per second, Mbps).

When the first device is the third device, a first service type may be determined by the third device based on service information of the third device and the service information sent by the second device. When the first device is the another device different from the second device and the third device, a first service type may be determined by the third device based on the service information sent by the first device to the third device and the service information sent by the second device to the third device.

A service type supported by each pre-trained neural network model and a representation form of a first service type include those described in Implementation 1.1 and Implementation 1.2.

In Implementation 1.1, a service type supported by each pre-trained neural network model is one of service types such as eMBB, URLLC, and mMTC, and a first service type is one of the service types such as eMBB, URLLC, and mMTC. When the service type supported by the pre-trained neural network model is the same as the first service type, it indicates that the pre-trained neural network model supports the first service type, that is, supports the service type needed by the first device and the second device.

In addition, when the service information of each of the first device and the second device includes one of the service types such as eMBB, URLLC, and mMTC, a service type included in the service information of the first device is the same as a service type included in the service information of the second device, and the same service type is the first service type. Optionally, the same service type included in the service information of the first device and the service information of the second device may be agreed upon in advance between the first device and the second device.

When the service information of each of the first device and the second device includes requirements of the device on performance indicators such as a communication latency and a throughput of the neural network model, the third device may determine a first service type from the service types such as eMBB, URLLC, and mMTC based on the service information of the first device and the service information of the second device, and the determined first service type can meet performance requirements of the first device and the second device.

When the service information of the first device includes one of the service types such as eMBB, URLLC, and mMTC, and the service information of the second device includes requirements of the second device on performance indicators such as a communication latency and a throughput of the neural network model, the third device may determine whether a service type included in the service information of the first device can meet the performance requirement of the second device; and if the service type included in the service information of the first device can meet the performance requirement of the second device, the service type included in the service information of the first device is used as the first service type. In addition, a case in which the service information of the first device includes the requirements of the first device on the performance indicators such as the communication latency and the throughput of the neural network model, and the service information of the second device includes one of the service types such as eMBB, URLLC, and mMTC is similar to this case. Details are not described again.

Implementation 1.2: A service type supported by each pre-trained neural network model is represented in a form of one or more performance indicators, and a first service type is represented by using a value range of each of the one or more performance indicators. When a value of each performance indicator in the service type supported by the pre-trained neural network model falls within a value range of the performance indicator in the first service type, it indicates that the pre-trained neural network model supports the first service type, that is, supports the service type needed by the first device and the second device.

In addition, when the service information of each of the first device and the second device includes requirements of the device on performance indicators such as a communication latency and a throughput of the neural network model, a value range of each performance indicator represented by the first service type is included in an intersection set of the performance requirement of the first device and the performance requirement of the second device. For example, the service information of the first device includes that the communication latency of the neural network model is less than a value #1, and the throughput is greater than a value #2; and the service information of the second device includes that the communication latency of the neural network model is less than a value #3, and the throughput is greater than a value #4. In this case, the first service type may be represented as follows: The communication latency of the neural network model is less than a value #5, and the throughput is greater than a value #6, where the value #5 is less than or equal to a smallest one of the value #1 and the value #3, and the value #6 is greater than or equal to a largest one of the value #2 and the value #4.

When the service information of each of the first device and the second device includes one of the service types such as eMBB, URLLC, and mMTC, the service type included in the service information of the first device is the same as the service type included in the service information of the second device. A value range of each performance indicator represented by the first service type is included in a value range of each performance indicator supported by the same service type. For example, both the service information of the first device and the service information of the second device include a service type 1, and a communication latency of a neural network model supported by the service type 1 is less than the value #1. In this case, the first service type may be represented as follows: The communication latency of the neural network model is less than the value #3, where the value #3 is less than or equal to the value #1.

When the service information of the first device includes one of the service types such as eMBB, URLLC, and mMTC, and the service information of the second device includes requirements of the second device on performance indicators such as a communication latency and a throughput of the neural network model, a value range of each performance indicator represented by the first service type is included in an intersection set of a value range of each performance indicator supported by the service type included in the service information of the first device and the performance requirement of the second device. For example, the service information of the first device includes a service type 1, and a communication latency of a neural network model supported by the service type 1 is less than the value #1. The service information of the second device includes that the communication latency of the neural network model is less than the value #2. In this case, the first service type may be represented as follows: The communication latency of the neural network model is less than the value #3, where the value #3 is less than or equal to a smallest one of the value #1 and the value #2. In addition, a case in which the service information of the first device includes the requirements of the first device on the performance indicators such as the communication latency and the throughput of the neural network model, and the service information of the second device includes one of the service types such as eMBB, URLLC, and mMTC is similar to this case. Details are not described again.

Optionally, based on Implementation 1.1 and Implementation 1.2, the communication method may further include: The second device sends the service information and the communication system parameters to the third device. The third device determines the first service type based on the service information of the first device and the service information of the second device, then determines the one or more second neural network models from the one or more pre-trained neural network models based on the first service type and the communication system parameters of the first device and/or the communication system parameters of the second device, and determines the third neural network model from the one or more second neural network models. For descriptions of the second neural network model, the service information and the communication system parameters of the first device, and the service information and the communication system parameters of the second device, refer to the foregoing related descriptions. Details are not described herein again.

That the third device determines the one or more second neural network models from the one or more pre-trained neural network models based on the first service type and the communication system parameters of the first device and/or the communication system parameters of the second device may include: The third device determines, from the one or more pre-trained neural network models, one or more pre-trained neural network models that support the first service type, and then determines, from the pre-trained neural network models that support the first service type and based on the communication system parameters of the first device and/or the communication system parameters of the second device, the one or more second neural network models whose input dimension is equal to a first input dimension corresponding to the one or more second neural network models and/or whose output dimension is equal to a first output dimension corresponding to the one or more second neural network models;
may include: The third device determines, from the one or more pre-trained neural network models based on the communication system parameters of the first device and/or the communication system parameters of the second device, pre-trained neural network models whose input dimensions are equal to first input dimensions corresponding to the pre-trained neural network models and/or whose output dimensions are equal to first output dimensions corresponding to the pre-trained neural network models, and then determines, from the determined pre-trained neural network models, the one or more second neural network models that support the first service type; or
may include: The third device determines, from the one or more pre-trained neural network models, one or more pre-trained neural network models that support the first service type, in addition, the third device determines, from the one or more pre-trained neural network models based on the communication system parameters of the first device and/or the communication system parameters of the second device, pre-trained neural network models whose input dimensions are equal to first input dimensions corresponding to the pre-trained neural network models and/or whose output dimensions are equal to first output dimensions corresponding to the pre-trained neural network models, and then, the third device uses, as the second neural network model, the same pre-trained neural network model obtained in the foregoing two operations. For example, the third device determines a pre-trained neural network model 1 and a pre-trained neural network model 2 that support the first service type. In addition, the third device determines the pre-trained neural network model 2 and a pre-trained neural network model 3 whose input dimensions are equal to first input dimensions corresponding to the two pre-trained neural network models and/or whose output dimensions are equal to first output dimensions corresponding to the two pre-trained neural network models. In this case, the pre-trained neural network model 2 is used as the second neural network model.

In an optional implementation, if there is one second neural network model, the third neural network model is the second neural network model. If there are a plurality of second neural network models, the third neural network model is a second neural network model with a largest parameter amount in the plurality of second neural network models. In this implementation, the determined third neural network model may be a second neural network model with best performance in the plurality of second neural network models.

Alternatively, the third neural network model is a second neural network model with a smallest absolute difference between an operation amount and a first operation amount in a plurality of second neural network models, where the first operation amount may be determined based on a computing power and a latency requirement of the first device and/or a computing power and a latency requirement of the second device. In this implementation, the determined third neural network model may be a second neural network model that is in the plurality of second neural network models and whose operation amount is closest to a maximum range supported by operation capabilities of the first device and the second device.

Alternatively, the third neural network model is a second neural network model with a smallest absolute difference between a parameter amount and a first parameter amount in the plurality of second neural network models, where the first parameter amount may be determined based on a computing power and storage space of the first device, and/or a computing power and storage space of the second device. In this implementation, the determined third neural network model may be a second neural network model that is in the plurality of second neural network models and whose parameter amount is closest to a maximum range supported by storage capabilities of the first device and the second device.

An absolute difference between an operation amount of each second neural network model and the first operation amount is an absolute value of a difference between the operation amount of the second neural network model and the first operation amount. An absolute difference between a parameter amount of each second neural network model and the first parameter amount is an absolute value of a difference between the parameter amount of the second neural network model and the first parameter amount.

In this embodiment of this application, the computing power of either the first device or the second device may be represented as floating-point operations that can be performed by the device per second, and a unit of the computing power is, for example, floating-point operations per second (floating-point operations per second, flop/s). The latency requirement of either the first device or the second device is a requirement of the device on a calculation latency of the neural network model. The calculation latency of the neural network model is time needed by the neural network model to calculate a specific floating-point number, and a unit of the calculation latency is, for example, second (second, s). The storage space of either the first device or the second device is storage space that can be used when the device performs communication based on the neural network model, and a unit of the storage space may be byte (byte). A unit of the first operation amount is, for example, flop, and a unit of the first parameter amount is, for example, byte. Optionally, the computing power, the latency requirement, and the storage space of the second device may be sent by the second device to the third device. If the first device is the another device different from the second device and the third device, the computing power, the latency requirement, and the storage space of the first device may be sent by the first device to the third device. The foregoing related descriptions of the first operation amount and the first parameter amount are applicable to any location of the first operation amount and the first parameter amount mentioned in this embodiment of this application. Details are not described below again.

It can be learned that when there is only one pre-trained neural network model, if an input dimension of the pre-trained neural network model is the same as a first input dimension corresponding to the pre-trained neural network model, and/or an output dimension of the pre-trained neural network model is the same as a first output dimension corresponding to the pre-trained neural network model, and the pre-trained neural network model supports the first service type, the pre-trained neural network model is the second neural network model, and is also the third neural network model. When there are a plurality of pre-trained neural network models, the third device may determine one or more second neural network models from the plurality of pre-trained neural network models, and then determine a third neural network model from the one or more second neural network models.

For related descriptions of determining, by the third device, the first neural network model based on the third neural network model selected from the one or more second neural network models, refer to Implementation 2.1 to Implementation 2.3.

In Implementation 2.1, the first neural network model is obtained by performing distillation (distillation) on the third neural network model. An operation amount of the third neural network model is greater than a first operation amount, and/or a parameter amount of the third neural network model is greater than a first parameter amount. The distillation is performed on the third neural network model, so that the operation amount and/or the parameter amount of the third neural network model can be reduced while it is ensured that impact on performance of the third neural network model is minimized. Therefore, an obtained operation amount of the first neural network model falls within a range supported by the operation capabilities of the first device and the second device, and a parameter amount falls within a range supported by the storage capabilities of the first device and the second device. For specific descriptions of the first operation amount and the first parameter amount, refer to the foregoing related descriptions. Details are not described herein again.

Optionally, in a process of obtaining the first neural network model by performing distillation on the third neural network model, distillation may be further performed with reference to reference data. The reference data reflects environment features and data features of the first device and the second device. In this implementation, the first neural network model can better adapt to a scenario of the communication between the first device and the second device. This helps improve performance of the adjusted first neural network model when being used for the communication between the first device and the second device, so that communication quality between the first device and the second device can be improved. Optionally, the reference data may be determined based on historical data of the first device and historical data of the second device that are collected by the third device. For example, reference data related to a channel may be obtained based on a historical channel estimation value of the channel between the first device and the second device; and reference data related to a data service between the first device and the second device may be obtained based on a historical service flow between the first device and the second device.

Implementation 2.2: The first neural network model is the third neural network model. An operation amount of the third neural network model is less than or equal to a first operation amount, and/or a parameter amount of the third neural network model is less than or equal to a first parameter amount. It can be learned that, if the operation amount and the parameter amount of the third neural network model respectively fall within the ranges supported by the operation capabilities and the storage capabilities of the first device and the second device, the first device may directly use the third neural network model as the first neural network model. For specific descriptions of the first operation amount and the first parameter amount, refer to the foregoing related descriptions. Details are not described herein again.

In addition, when the operation amount of the third neural network model is equal to the first operation amount, and/or the parameter amount of the third neural network model is equal to the first parameter amount, the third neural network model may alternatively not be used as the first neural network model, but the first neural network model is obtained by performing distillation on the third neural network model.

Optionally, based on Implementation 2.1 and Implementation 2.2, when the third device stores the one or more pre-trained neural network models, the communication method may further include: When the operation amount of the third neural network model is greater than the first operation amount, and/or the parameter amount of the third neural network model is greater than the first parameter amount, the third device performs distillation on the third neural network model to obtain the first neural network model. Alternatively, when the operation amount of the third neural network model is less than or equal to the first operation amount, and/or the parameter amount of the third neural network model is less than or equal to the first parameter amount, the third neural network model is used as the first neural network model.

Implementation 2.3: The first neural network model is determined by a model server based on received model request information. The model request information includes an identifier of the third neural network model, and a first operation amount and/or a first parameter amount. The model request information is sent by the third device to the model server, and the first neural network model is received by the third device from the model server. It can be learned that this implementation may be applied to a case in which the third device may obtain the first neural network model from the model server when the model server stores one or more pre-trained neural network models. For specific descriptions of the first operation amount and the first parameter amount, refer to the foregoing related descriptions. Details are not described herein again.

Optionally, when the third device does not store the one or more pre-trained neural network models, and the model server stores the one or more pre-trained neural network models, the communication method further includes: The third device sends the model request information to the model server, where the model request information includes the identifier of the third neural network model, and the first operation amount and/or the first parameter amount. The model server may determine the third neural network model from the one or more pre-trained neural network models based on the identifier of the third neural network model in the model request information, and then send the first neural network model to the third device after determining the first neural network model based on the third neural network model and the first operation amount and/or the first parameter amount in the model request information. Correspondingly, the third device receives the first neural network model from the model server.

Specifically, that the model server determines the first neural network model based on the third neural network model, and the first operation amount and the first parameter amount in the model request information may include: When an operation amount of the third neural network model is greater than the first operation amount, and/or a parameter amount of the third neural network model is greater than the first parameter amount, the model server performs distillation on the third neural network model to obtain the first neural network model. Alternatively, when an operation amount of the third neural network model is less than or equal to the first operation amount, and/or a parameter amount of the third neural network model is less than or equal to the first parameter amount, the third neural network model is used as the first neural network model.

Optionally, information about the pre-trained neural network model includes one or more of the following: an identifier (ID), the service type, the size of the RP, the input dimension, the output dimension, the parameter amount, and the operation amount. Different pre-trained neural network models have different identifiers. Optionally, the information about the pre-trained neural network model is predefined. For example, the third device may obtain information about each defined pre-trained neural network model from a standard text and product descriptions. Alternatively, the information about the pre-trained neural network model is obtained from the model server. For example, the model server actively sends the information about the pre-trained neural network model to the third device. Alternatively, the third device requests to obtain the information about the pre-trained neural network model from the model server, and the model server then sends the information to the third device. It can be learned that the identifier of the third neural network model may be determined by the third device based on information about each of the one or more pre-trained neural network models.

In this embodiment of this application, the pre-trained neural network model may include a submodel. Specifically, the pre-trained neural network model may include a transmitter submodel and a receiver submodel. The transmitter submodel is used to process a to-be-sent signal and send a processed signal, and the receiver submodel is used to receive a signal and process the received signal. Herein, a manner of naming the two submodels by using the “transmitter submodel” and the “receiver submodel” is merely an example of a naming manner. Alternatively, a “first submodel” and a “second submodel” may be used for naming. This is not limited herein. The following uses the naming manner of the “transmitter submodel” and the “receiver submodel” as an example for description.

The input dimension of the pre-trained neural network model is an input dimension of the transmitter submodel in the pre-trained neural network model, the output dimension is an output dimension of the receiver submodel in the pre-trained neural network model, the parameter amount is a sum of a parameter amount of the transmitter submodel and a parameter amount of the receiver submodel, and the operation amount is a sum of an operation amount of the transmitter submodel and an operation amount of the receiver submodel. In addition, in this embodiment of this application, the performing distillation, adjustment, and other processing on a pre-trained neural network model includes: processing both the transmitter submodel and the receiver submodule in the pre-trained neural network model. For example, the performing distillation on the third neural network model includes performing distillation on a transmitter submodel and a receiver submodel in the third neural network model. It can be learned that the first neural network model also includes a transmitter submodel and a receiver submodel. If the first neural network model is obtained by performing distillation on the third neural network model, the transmitter submodel in the first neural network model is obtained by performing distillation on the transmitter submodel in the third neural network model, and the receiver submodel in the first neural network model is obtained by performing distillation on the receiver submodel in the third neural network model.

This embodiment of this application further provides Table 1, to show an example of information about each of one or more pre-trained neural network models.

TABLE 1

| | | Time | | Frequency | | | | | |
|---|---|---|---|---|---|---|---|---|---|
| | | domain | | domain | | | | | |
| | Service | length of | | width of | | Input | Output | Parameter | Operation |
| Identifier | type | an RP | | the RP | | dimension | dimension | amount | amount |
| 1 | eMBB | 1 | ms | 180 | kHz | I₁ | O₁ | D₁ | F₁ |
| 2 | eMBB | 0.5 | ms | 180 | kHz | I₂ | O₂ | D₂ | F₂ |
| 3 | mMTC | 0.5 | ms | 60 | kHz | I₃ | O₃ | D₃ | F₃ |

. . .

| | | | | | | | | | |
|---|---|---|---|---|---|---|---|---|---|
| N | mMTC | 0.25 | ms | 15 | kHz | I_{N} | O_{N} | D_{N} | F_{N} |

In addition, in addition to a manner shown in Table 1 in which information about each of the plurality of pre-trained neural network models is presented in the same table, the plurality of pre-trained neural network models may be further classified based on any class of information about the pre-trained neural network models, where same classes of information about pre-trained neural network models are presented in a same table, and different classes of information about pre-trained neural network models are presented in different tables. For example, information about the plurality of pre-trained neural network models is separately presented in a plurality of tables based on service types supported by the pre-trained neural network models, where a same service type supported by pre-trained neural network models is included in a same table, and different service types supported by pre-trained neural network models are included in different tables, as shown in Table 2 and Table 3. All pre-trained neural network models in Table 2 support eMBB, and all pre-trained neural network models in Table 3 support mMTC. Optionally, entries in Table 2 and Table 3 may not include the service type, or may include the service type. This is not limited herein. For another example, the information about the plurality of pre-trained neural network models is separately presented in a plurality of tables based on frequency domain widths that are of RPs and that are applicable to the pre-trained neural network models. A manner of presenting information about each of the one or more pre-trained neural network models is not limited herein.

TABLE 2

| | Time | | Frequency | | | | |
|---|---|---|---|---|---|---|---|
| | domain | | domain | | | | |
| | length of | | width of | Input | Output | Parameter | Operation |
| Identifier | an RP | | the RP | dimension | dimension | amount | amount |
| 1 | 1 | ms | 180 kHz | I₁ | O₁ | D₁ | F₁ |
| 2 | 0.5 | ms | 180 kHz | I₂ | O₂ | D₂ | F₂ |

TABLE 3

| | Time | | Frequency | | | | |
|---|---|---|---|---|---|---|---|
| | domain | | domain | | | | |
| | length of | | width of | Input | Output | Parameter | Operation |
| Identifier | an RP | | the RP | dimension | dimension | amount | amount |
| 1 | 0.5 | ms | 60 kHz | I₃ | O₃ | D₃ | F₃ |
| 2 | 0.25 | ms | 15 kHz | I_{N} | O_{N} | D_{N} | F_{N} |

S102: The third device adjusts the first neural network model based on first information, where the first information includes communication resource information and/or channel state information for the communication between the first device and the second device.

That the third device adjusts the first neural network model based on first information includes: The third device adjusts the transmitter submodel and the receiver submodel in the first neural network model. In this case, an adjusted transmitter submodel in the first neural network model is obtained by adjusting the transmitter submodel in the first neural network model, and an adjusted receiver submodel in the first neural network model is obtained by adjusting the receiver submodel in the first neural network model.

In an optional implementation, the adjusted first neural network model is obtained by training a fourth neural network model based on the channel state information in the first information; and the fourth neural network model is obtained by adjusting an input dimension and/or an output dimension of the first neural network model based on a size that is of an RP and that is applicable to the first neural network model and the communication resource information in the first information. Optionally, the communication resource information in the first information includes resources used for the communication between the first device and the second device, and the resources may include a time domain resource, a frequency domain resource, a space domain resource, and another resource. Different from the resources that are represented by the communication system parameters and on which the device can operate, the resources used for the communication between the first device and the second device are some or all of resources on which the first device and the second device can operate together in the resources on which the first device and the second device can operate, and are also resources that can be actually used when the first device and the second device communicate with each other based on the neural network model. Optionally, the resources used for the communication between the first device and the second device may be allocated by the third device to the first device and the second device, or may be allocated by another device different from the third device to the first device and the second device. This is not limited herein. In addition, for descriptions of the size that is of the RP and that is applicable to the first neural network model, refer to the foregoing related descriptions. Details are not described herein again.

Optionally, if the communication performed between the first device and the second device by using the neural network model is unidirectional communication, to be specific, only one device of the first device and the second device is used as a sender in the communication, and the other device is used as a receiver in the communication, the channel state information in the first information may be obtained by performing channel estimation by the device as the receiver in the first device and the second device. If the communication performed between the first device and the second device by using the neural network model is bidirectional communication, to be specific, the first device is used as both a sender and a receiver in the communication, and the second device is used as both a sender and a receiver in the communication, the channel state information in the first information includes information obtained by separately performing channel estimation by the first device and the second device. The information obtained by the second device by performing channel estimation may be sent by the second device to the third device. If the first device is the another device different from the second device and the third device, the information obtained by the first device by performing channel estimation may be sent by the first device to the third device.

Optionally, the communication method may further include: If a second input dimension determined based on the size that is of the RP and that is applicable to the first neural network model and the communication resource information in the first information is less than the input dimension of the first neural network model, the third device adjusts the input dimension of the first neural network model to the second input dimension, that is, an input dimension of the fourth neural network model is the second input dimension; or if a second input dimension determined based on the size that is of the RP and that is applicable to the first neural network model and the communication resource information in the first information is greater than or equal to the input dimension of the first neural network model, an input dimension of the fourth neural network model is equal to the input dimension of the first neural network model, that is, the input dimension of the first neural network model does not need to be adjusted.

Optionally, the communication method may further include: If a second output dimension determined based on the size that is of the RP and that is applicable to the first neural network model and the communication resource information in the first information is less than the output dimension of the first neural network model, the third device adjusts the output dimension of the first neural network model to the second output dimension, that is, an output dimension of the fourth neural network model is the second output dimension; or if a second output dimension determined based on the size that is of the RP and that is applicable to the first neural network model and the communication resource information in the first information is greater than or equal to the output dimension of the first neural network model, an output dimension of the fourth neural network model is equal to the output dimension of the first neural network model, that is, the output dimension of the first neural network model does not need to be adjusted.

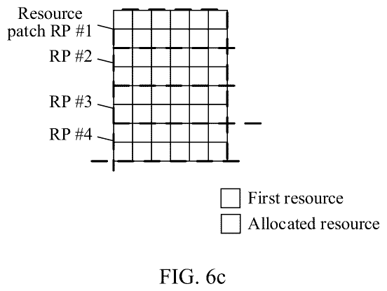

An example in which the input dimension of the first neural network model is adjusted is used. With reference to FIG. 6a, the input dimension of the first neural network model is 4. If the second input dimension determined based on the size that is of the RP and that is applicable to the first neural network model and the communication resource information in the first information is 2, the input dimension of the first neural network model is adjusted to 2, that is, the input dimension of the fourth neural network model is 2.

Specifically, if the size that is of the RP and that is applicable to the first neural network model is determined based on a time domain length S₁ of the RP and a frequency domain width B₁ of the RP that are applicable to the first neural network model, and the communication resource information includes a time domain resource and a frequency domain resource used for the communication between the first device and the second device, the second input dimension or the second output dimension is equal to

$$ceil ( \frac{{B}_{2}}{{B}_{1}} ) \times ceil ( \frac{{S}_{2}}{{S}_{1}} ) .$$

S₂ is a length of the time domain resource allocated to the first device and the second device, B₂ is a width of the frequency domain resource allocated to the first device and the second device, and ceil( ) is a rounding-up function.

In another optional implementation, the adjusted first neural network model is obtained by training a fourth neural network model based on the channel state information in the first information; and the fourth neural network model is obtained by adjusting an input value and/or an output value of the first neural network model based on a size that is of an RP and is applicable to the first neural network model and the communication resource information in the first information. For descriptions of the size that is of the RP and that is applicable to the first neural network model, and the communication resource information and the channel state information in the first information, refer to the foregoing related descriptions. Details are not described herein again.

Optionally, the communication method may further include: If a second input dimension determined based on the size that is of the RP and that is applicable to the first neural network model and the communication resource information in the first information is less than the input dimension of the first neural network model, the third device sets M1 input values of the first neural network model to zero, that is, M1 input values of the fourth neural network model are 0. M1 is equal to a value obtained by subtracting the second input dimension from the input dimension of the first neural network model. Optionally, the communication method may further include: If a second output dimension determined based on the size that is of the RP and that is applicable to the first neural network model and the communication resource information in the first information is less than the output dimension of the first neural network model, the third device sets M2 output values of the first neural network model to zero, that is, M2 output values of the fourth neural network model are 0. M2 is equal to a value obtained by subtracting the second output dimension from the output dimension of the first neural network model. For specific descriptions of the second input dimension and the second output dimension, refer to the foregoing related descriptions. Details are not described herein again.

An example in which the input dimension of the first neural network model is adjusted is used. With reference to FIG. 6b, the input dimension of the first neural network model is 4. If the second input dimension determined based on the size that is of the RP and that is applicable to the first neural network model and the communication resource information in the first information is 2, it indicates that the second input dimension is less than the input dimension of the first neural network model. In this case, two input values of the first neural network model are set to zero, that is, two input values of the fourth neural network model are 0.

Optionally, the communication method may further include: The third device determines an RP corresponding to each input and/or each output of the first neural network model in a first resource, where different inputs and/or outputs correspond to different RPs. The first resource is a resource on which the first device and the second device can operate together in a resource represented by the communication system parameters of the first device and a resource represented by the communication system parameters of the second device. If the second input dimension is less than the input dimension of the first neural network model, an input value of an input corresponding to a resource that is in the first resource and that is not allocated to the first device and the second device is set to zero, and/or if the second output dimension is less than the output dimension of the first neural network model, an output value of an output corresponding to the resource that is in the first resource and that is not allocated to the first device and the second device is set to zero. For example, with reference to FIG. 6c, the input dimension of the first neural network model is 4. In addition, in the resource (namely, the first resource) on which the first device and the second device can operate together, an input #1 of the first neural network model corresponds to an RP #1, an input #2 corresponds to an RP #2, an input #3 corresponds to an RP #3, and an input #4 corresponds to an RP #4. If resources used for the communication between the first device and the second device include the RP #1 and the RP #2, and do not include the RP #3 and the RP #4, an input value of the input #3 of the first neural network model corresponding to the RP #3 is set to zero, and an input value of the input #4 of the first neural network model corresponding to the RP #4 is set to zero.

Optionally, the first information may further include device status information of the first device and/or device status information of the second device. In the foregoing two implementations, in the process of training the fourth neural network model to obtain the adjusted first neural network model, in addition to training the fourth neural network model based on the channel state information in the first information, the fourth neural network model may be further trained with reference to the device status information of the first device and/or the device status information of the second device. The device status information of either the first device or the second device may include load (for example, central processing unit (central processing unit, CPU) load or a memory) and a battery level of the device. Optionally, in a process of training the fourth neural network model to obtain the adjusted first neural network model, distillation may be further performed on the fourth neural network model, to further reduce a parameter amount and an operation amount of the fourth neural network model.

S103: The third device sends the adjusted first neural network model. Correspondingly, the second device receives the adjusted first neural network model. Alternatively, the third device sends a submodel in the adjusted first neural network model. Correspondingly, the second device receives the submodel in the adjusted first neural network model. The adjusted first neural network model is used for the communication between the first device and the second device.

S104: The second device performs communication based on the adjusted first neural network model. Alternatively, the second device performs communication based on the submodel in the adjusted first neural network model.

The following separately describes an implementation in which the third device sends the adjusted first neural network model and an implementation in which the submodel in the adjusted first neural network model.

Implementation 3.1: The third device sends the adjusted first neural network model.

If the first device is the third device, the third device sends the adjusted first neural network model to the second device. If the first device is the another device different from the second device and the third device, the third device separately sends the adjusted first neural network model to the first device and the second device.

If the first device is used as the sender and the second device is used as the receiver in the communication between the first device and the second device, the first device may determine a transmitter submodel from the adjusted first neural network model, process a to-be-sent signal based on the transmitter submodel, and send a signal to the second device. The second device may determine a receiver submodel from the adjusted first neural network model, receive a signal from the first device based on the receiver submodel, and process the received signal. A case in which the second device is used as the sender in the communication and the first device is used as the receiver in the communication is similar to this case. Details are not described again.

In implementation 3.2: The third device sends the submodel in the adjusted first neural network model.

When the first device is the third device, if the second device is used as the sender in the communication, the submodel that is in the adjusted first neural network model and that is sent by the third device to the second device is a transmitter submodel in the adjusted first neural network model; or if the second device is used as the receiver in the communication, the submodel that is in the adjusted first neural network model and that is sent by the third device to the second device is a receiver submodel in the adjusted first neural network model.

When the first device is the another device different from the second device and the third device, if the first device is used as the sender in the communication and the second device is used as the receiver in the communication, the third device sends a transmitter submodel in the adjusted first neural network model to the first device, and sends a receiver submodel in the adjusted first neural network model to the second device. If the second device is used as the sender in the communication and the first device is used as the receiver in the communication, the third device sends a transmitter submodel in the adjusted first neural network model to the second device, and sends a receiver submodel in the adjusted first neural network model to the first device. In addition, when the communication between the first device and the second device is the bidirectional communication, to be specific, the first device is used as both the sender and the receiver, and the second device is used as both the sender and the receiver, if in unidirectional communication in two reverse directions of the mutual communication included in the bidirectional communication, the system bandwidths supported by the first device and the second device have a same smallest value, the frame lengths corresponding to the supported frame structures have a same smallest value, and the resources used for the communication between the first device and the second device have a same size, the first device and the second device may perform the bidirectional communication based on the determined adjusted first neural network model. The first device as the sender performs the communication by using the transmitter submodel in the adjusted first neural network model, and the first device as the receiver performs the communication by using the receiver submodel in the adjusted first neural network model. A case in which the second device is separately used as the sender and the receiver is similar to this case. Details are not described again. If the system bandwidths supported by the first device and the second device have the same smallest value, the frame lengths corresponding to the supported frame structures have the same smallest value, and the resources used for the communication between the first device and the second device have the same size, the third device needs to separately perform the communication method provided in this embodiment of this application for each of the unidirectional communication in two reverse directions of the mutual communication, to separately obtain a neural network model used for the communication between the first device and the second device in unidirectional communication in each direction.

In an optional implementation, after that the third device sends the adjusted first neural network model, or sends a submodel in the adjusted first neural network model, the communication method may further include: The third device obtains a performance indicator for the communication performed between the first device and the second device based on the adjusted first neural network model. The performance indicator includes one or more of the following: a throughput, a bit error rate, a packet loss rate, a communication latency, or the like. If the performance indicator does not meet a preset condition, the third device obtains a fifth neural network model. The fifth neural network model is obtained by the first device and the second device by jointly training the adjusted first neural network model. It can be learned that, that the performance indicator does not meet a preset condition may indicate that quality of the communication performed based on the adjusted first neural network model is low, that is, performance of the adjusted first neural network model is low when the adjusted first neural network model is used for the communication between the first device and the second device. In this case, the first device and the second device jointly train the adjusted first neural network model, so that performance of the adjusted first neural network model can be improved.

If the performance indicator is the throughput, the preset condition is that the throughput is greater than a first value. If the performance indicator is the bit error rate, the preset condition is that the bit error rate is less than a second value. If the performance indicator is the packet loss rate, the preset condition is that the packet loss rate is less than a third value. If the performance indicator is the communication latency, the preset condition is that the communication latency is less than a fourth value. A preset condition corresponding to another performance indicator is similar to that described above. Details are not described herein again. Optionally, the first value may be preset, or may be defined in a protocol. A manner of determining a threshold (such as the second value, the third value, or the fourth value) in a preset condition corresponding to another performance indicator is similar to that of determining the first value. Details are not described again.

That the first device and the second device jointly train the adjusted first neural network model may include: The device as the receiver in the first device and the second device calculates a gradient value of a parameter of the receiver submodel in the adjusted first neural network model by using a loss function, and updates the parameter of the receiver submodel based on the gradient value obtained through calculation. The device as the receiver further sends the gradient value of the parameter of the receiver submodel to the device as the sender in the first device and the second device. In this case, the device as the sender may calculate, based on the received gradient value, a gradient value of a parameter of the transmitter submodel in the adjusted first neural network model, and update the parameter of the transmitter submodel based on the gradient value obtained through calculation. In other words, a transmitter submodel in the fifth neural network model is obtained by updating the parameter of the transmitter submodel in the adjusted first neural network model, and a receiver submodel in the fifth neural network model is obtained by updating the parameter of the receiver submodel in the adjusted first neural network model.

Optionally, the performance indicator for the communication performed based on the adjusted first neural network model may be obtained by the third device irregularly or periodically. In this case, the third device may obtain a change trend of the performance indicator for the communication performed between the first device and the second device based on the adjusted first neural network model, to obtain a change trend of performance that is of the adjusted first neural network model and that is obtained by using the adjusted first neural network model for the communication between the first device and the second device. This manner helps the first device and the second device jointly train the adjusted first neural network model in time when it is determined that the performance of the adjusted first neural network model gradually deteriorates, to reduce impact caused by the performance deterioration of the adjusted first neural network model on the communication quality between the first device and the second device.

Optionally, if the third device stores the one or more pre-trained neural network models, the communication method further includes: The third device updates the third neural network model in the one or more pre-trained neural network models based on the fifth neural network model. If the third device does not store the one or more pre-trained neural network models, and the model server stores the one or more pre-trained neural network models, the communication method may further include: The third device sends the fifth neural network model to the model server. The model server updates the third neural network model in the one or more pre-trained neural network models based on the fifth neural network model. Optionally, an operation of updating, by the third device or the model server, the third neural network model in the one or more pre-trained neural network models may be implemented in a transfer learning manner.

In addition, a common air interface may be pre-established between the third device and the second device. When the first device is the another device different from the second device and the third device, a common air interface is further pre-established between the third device and the first device, and a common air interface may be pre-established between the first device and the second device. If the model server further exists in a communication system, a common air interface may be further pre-established between the third device and the model server. The common air interface may be established based on one or more of modules such as channel encoding, modulation, resource mapping, and precoding models, or may be established based on a neural network in an AI technology. This is not limited herein.

In the communication method, before the communication is performed between the first device and the second device based on the adjusted first neural network model, a common air interface may be used for transmission of information exchanged between different devices. The information exchanged between the different devices may include some or all of the following: the communication system parameters, the service information, the computing power, the latency requirement, the storage space, the channel state information, the device status information, and the like that are sent by the second device to the third device, the information about each pre-trained neural network model or the first neural network model that is sent by the model server to the third device, the adjusted first neural network model or the submodel in the adjusted first neural network model that is sent by the third device to the second device, or the like. When the first device is the another device different from the second device and the third device, the information exchanged between the different devices may further include: the communication system parameters, the service information, the computing power, the latency requirement, the storage space, the channel state information, the device status information, and the like that are sent by the first device to the third device, the adjusted first neural network model or the submodel in the adjusted first neural network model that is sent by the third device to the first device, or the like.

After obtaining the adjusted first neural network model, the first device and the second device may establish an AI air interface based on the adjusted first neural network model. The AI air interface is different from the foregoing common air interface, and the AI air interface may be used for transmission of a signal (for example, data, information, or control signaling) for the communication performed between the first device and the second device based on the adjusted first neural network model. Alternatively, a signal for the communication performed between the first device and the second device based on the adjusted first neural network model may be alternatively directly reused through the common air interface for transmission. This is not limited herein.

In conclusion, in the communication method, the third device determines the first neural network model from the one or more pre-trained neural network models; and adjusts the first neural network model based on the communication resource information and/or the channel state information for the communication between the two devices, and sends an adjusted first neural network model, where the adjusted first neural network model is used for the communication between the two devices. In this case, the first device and the second device may perform communication based on the adjusted first neural network model. It can be learned that the neural network model used for the communication between the first device and the second device is obtained through adjustment based on the pre-trained neural network model that has been trained, and the determined neural network model adapts to a scenario of the communication between the first device and the second device. Compared with a manner in which the first device and the second device retrain a neural network model for the communication, this manner can reduce complexity of determining the neural network model, and can further reduce signaling overheads of interaction between the devices for determining the neural network model. In addition, compared with a manner in which a plurality of modules (for example, including encoding, modulation, multi-access, waveform, radio frequency, and other processing modules, where the modules may further include a plurality of submodules) are used between the first device and the second device to perform signal processing and transmission, this manner avoids impact on overall performance caused by separate design and optimization of the modules.

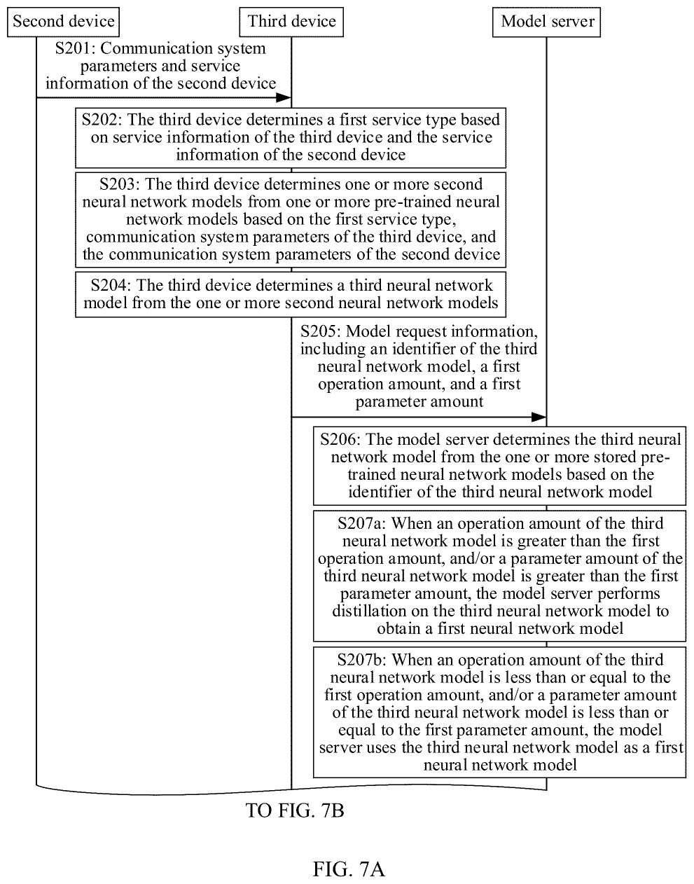

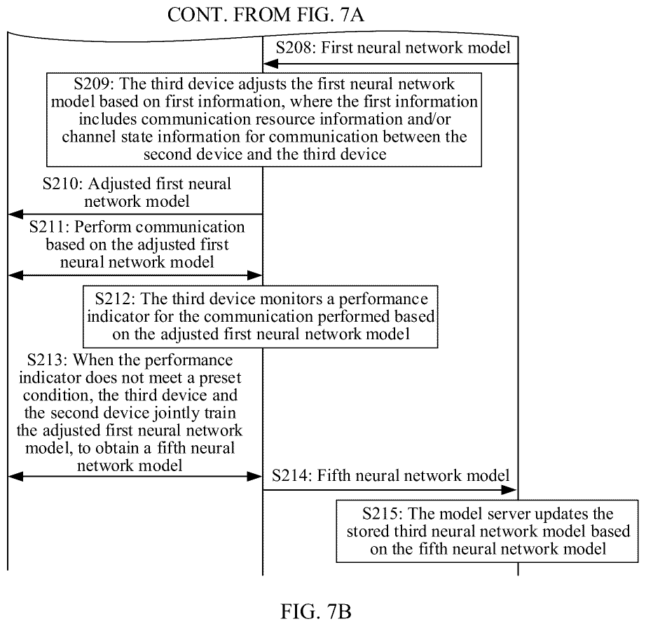

For example, the first device is a third device. An embodiment of this application further provides another communication method, as shown in FIG. 7A and FIG. 7B. The communication method shown in FIG. 7A and FIG. 7B is a specific implementation method of the communication method shown in FIG. 4. The communication method includes the following steps.

S201: A second device sends communication system parameters and service information of the second device to a third device. Correspondingly, the third device receives the communication system parameters and the service information of the second device. The service information of the second device may include one of service types such as eMBB, URLLC, and mMTC that is needed by the second device. Alternatively, the service information of the second device may include requirements of the second device on performance indicators such as a communication latency and a throughput of a neural network model.

S202: The third device determines a first service type based on service information of the third device and the service information of the second device. The service information of the third device may include one of service types such as eMBB, URLLC, and mMTC that is needed by the third device. Alternatively, the service information of the third device may include requirements of the third device on performance indicators such as a communication latency and a throughput of a neural network model.

S203: The third device determines one or more second neural network models from one or more pre-trained neural network models based on the first service type, communication system parameters of the third device, and the communication system parameters of the second device.

Each second neural network model supports the first service type, where an input dimension of each second neural network model is the same as a first input dimension corresponding to each second neural network model, and/or an output dimension of each second neural network model is the same as a first output dimension corresponding to each second neural network model. The first input dimension and/or the first output dimension corresponding to each second neural network model are/is determined based on a size that is of an RP and that is applicable to the second neural network model, and the communication system parameters of the third device and/or the communication system parameters of the second device.

S204: The third device determines a third neural network model from the one or more second neural network models.

When there is one second neural network model, the second neural network model is used as the third neural network model. When there are a plurality of second neural network models, a second neural network model with a largest parameter amount in the plurality of second neural network models is used as the third neural network model; a second neural network model with a smallest absolute difference between an operation amount and a first operation amount in the plurality of second neural network models is used as the third neural network model; or a second neural network model with a smallest absolute difference between a parameter amount and a first parameter amount in the plurality of second neural network models is used as the third neural network model.

S205: The third device sends model request information to a model server, where the model request information includes an identifier of the third neural network model, a first operation amount, and a first parameter amount. The first operation amount may be determined based on a computing power and a latency requirement of the third device and/or a computing power and a latency requirement of the second device; and the first parameter amount may be determined based on the computing power and storage space of the third device and/or the computing power and storage space of the second device.

S206: The model server determines the third neural network model from the one or more stored pre-trained neural network models based on the identifier of the third neural network model.

S207a: When an operation amount of the third neural network model is greater than the first operation amount, and/or a parameter amount of the third neural network model is greater than the first parameter amount, the model server performs distillation on the third neural network model to obtain the first neural network model.

S207b: When an operation amount of the third neural network model is less than or equal to the first operation amount, and/or a parameter amount of the third neural network model is less than or equal to the first parameter amount, the model server uses the third neural network model as the first neural network model.

S207a and S207b are parallel steps, and a specific step to be performed may be determined based on a result for a determined condition.

S208: The model server sends the first neural network model to the third device. Correspondingly, the third device receives the first neural network model from the model server.

S209: The third device adjusts the first neural network model based on first information. The first information includes communication resource information and/or channel state information for communication between the second device and the third device.

S210: The third device sends an adjusted first neural network model to the second device. Correspondingly, the second device receives the adjusted first neural network model.

S211: The third device and the second device perform communication based on the adjusted first neural network model.

S212: The third device monitors a performance indicator for the communication performed based on the adjusted first neural network model.

S213: When the performance indicator does not meet the preset condition, the third device and the second device jointly train the adjusted first neural network model, to obtain a fifth neural network model.

S214: The third device sends the fifth neural network model to the model server. Correspondingly, the model server receives the fifth neural network model.

S215: The model server updates the stored third neural network model based on the fifth neural network model.

For specific descriptions of the foregoing steps, refer to related descriptions in the communication method shown in FIG. 4. Details are not described herein again.

When the first device and the second device are a network device and a terminal device, in the communication method provided in this embodiment of this application, a neural network model used for uplink communication between the network device and the terminal device may be determined, or a neural network model used for downlink communication between the network device and the terminal device may be determined. When the first device and the second device are two terminal devices, in the communication method, a neural network model used for device-to-device (device-to-device, D2D) communication between the two terminal devices may be determined.

In addition, when a plurality of groups of devices all use neural network models for communication, a neural network model used by each group of devices may be further determined in the communication method provided in this embodiment of this application. Each group of devices in the plurality of groups of devices includes two devices that communicate with each other, and different groups of devices include at least one different device in two devices. For example, a group 1 includes a first device 1 and a second device 1, a group 2 includes the first device 1 and a second device 2, and a group 3 includes the first device 2 and a second device 3.

Specifically, when there are N1 groups of devices and each group of devices includes two devices that communicate with each other, the third device may separately determine, for each group of the N1 groups of devices from one or more pre-trained neural network models, a third neural network model corresponding to the group of devices. If N2 groups of devices correspond to the same third neural network model, and the model server stores the one or more pre-trained neural network models, the model server may perform an operation of obtaining the third neural network model based on an identifier of the third neural network once, and does not need to separately perform the operation of obtaining the third neural network model for the N2 groups of devices. The third device separately determines, for each group of the N1 groups of devices, a first neural network model corresponding to the group of devices, and steps S102, S103, and S104 in FIG. 4 are performed. Both N1 and N2 are integers greater than 1, and N2 is less than or equal to N1.

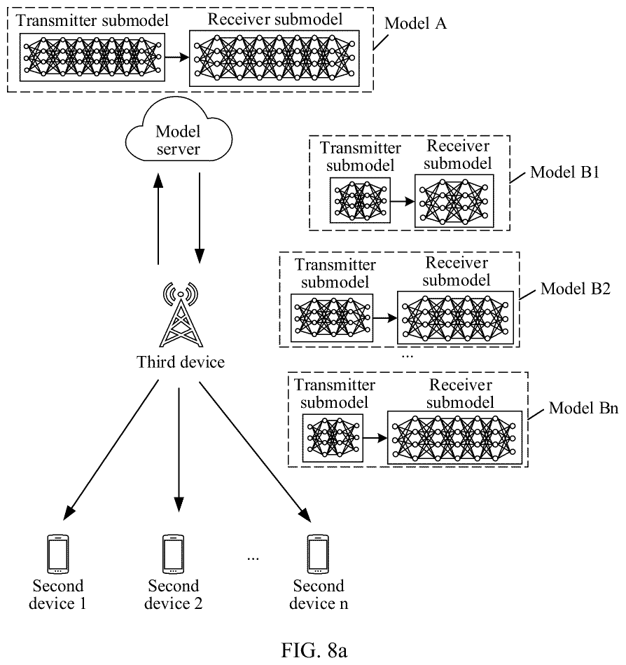

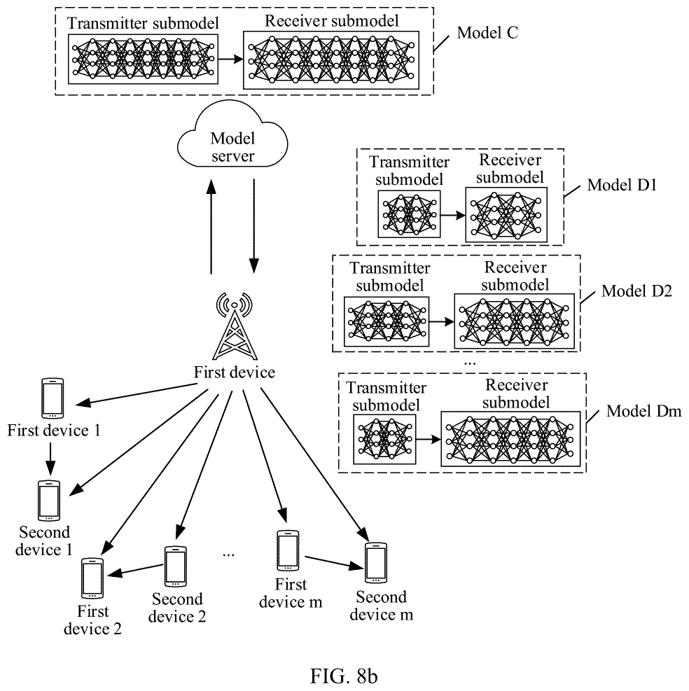

With reference to FIG. 8a, an example in which the first device is a third device, the third device is a network device, and the second device is a terminal device is used. There are n groups of devices (where n is an integer greater than 1). Each group of the n groups of devices includes a third device and a second device, and different groups of devices include different second devices. In addition, cellular network uplink communication is performed between the third device and the second device that are included in each group of the n groups of devices.

The third device determines a same third neural network model (namely, a model A) for the n groups of devices. In this case, for each group of the n groups of devices, the model server may determine a first neural network model based on the model A and a first operation amount and/or a first parameter amount corresponding to the group of devices, and send the determined first neural network model to the third device. The third device may obtain a first neural network model corresponding to each group of the n groups of devices, and perform, for each group of devices, the following step: adjusting the first neural network model based on communication resource information and/or channel state information for communication between two devices included in the group of devices, to obtain an adjusted first neural network model. That is, a model B₁ determined and corresponding to the third device and the second device 1, a model B2 determined and corresponding to the third device and the second device 2, . . . , and a model Bn determined and corresponding to the third device and a second device n are obtained. Then, the third device may send a transmitter submodel in the model B1 to the second device 1, send a transmitter submodel in the model B2 to the second device 2, . . . , and send a transmitter submodel in the model Bn to the second device n. In this case, when the third device performs uplink communication with the second device 1, the second device 1 processes a to-be-sent signal based on the transmitter submodel in the model B1 and sends a signal, and the third device receives the signal based on a receiver submodel in the model B1 and processes the received signal. A case in which the third device separately performs uplink communication with the second device 2, . . . , and the second device n is similar to the foregoing case in which the third device performs uplink communication with the second device 1. Details are not described herein again.

Similarly, when cellular network downlink communication is performed between the third device and the second device included in each group of the n groups of devices, the third device may separately determine an adjusted first neural network model for the n groups of devices, and send a receiver submodel in the adjusted first neural network model to the second device in each group of devices. When the third device performs downlink communication with each second device, the third device processes a to-be-sent signal based on a transmitter submodel in an adjusted first neural network model and sends a signal, and the second device receives the signal based on a receiver submodel in the adjusted first neural network model and processes the received signal.

With reference to FIG. 8b, an example in which the first device is another device different from a second device and a third device, the third device is a network device, and both the first device and the second device are terminal devices is used. There are m groups of devices (where m is an integer greater than 1), each group of the m groups of devices includes a first device and a second device, and there is at least one different device between different groups of devices. Communication between the first device and the second device included in each group of the m groups of devices is D2D.

The third device determines a same third neural network model (namely, a model C) for the m groups of devices. In this case, for each group of the m groups of devices, the model server may determine a first neural network model based on the model C and a first operation amount and/or a first parameter amount corresponding to the group of devices, and send the determined first neural network model to the third device. The third device may obtain a first neural network model corresponding to each group of the m groups of devices, and perform, for each group of devices, the following step: adjusting the first neural network model based on communication resource information and/or channel state information for communication between a first device and a second device included in the group of devices, to obtain an adjusted first neural network model. That is, a model D1 determined and corresponding to the first device 1 and the second device 1, a model D2 determined and corresponding to the first device 2 and the second device 2, . . . , and a model Dm determined and corresponding to a first device m and a second device m are obtained. Then, the third device may send a transmitter submodel in the model D1 to the first device 1 as a sender, and send a transmitter submodel in the model D2 to the second device 1 as a receiver; . . . ; and send a transmitter submodel in the model Dm to the first device m as a sender, and send a receiver submodel in the model Dm to the second device m as a receiver. In this case, the first device 1 may process a to-be-sent signal based on the transmitter submodel in the model D1 and sends a signal, and the second device 1 receives the signal based on a receiver submodel in the model D1 and processes the received signal. D2D between a first device and a second device included in another group of the m groups of devices is similar to the foregoing case of the D2D between the first device 1 and the second device 1. Details are not described herein again.

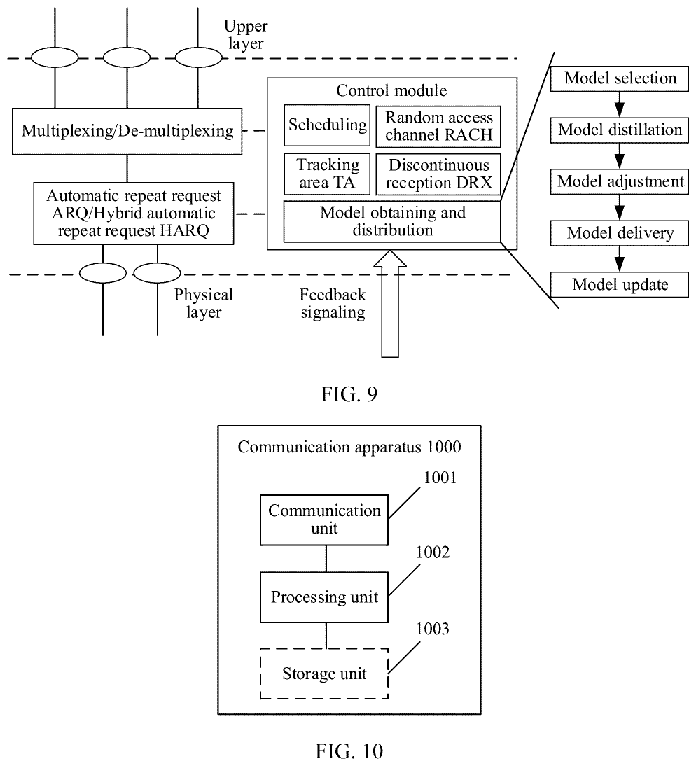

A related operation of the third device in the communication method provided in this embodiment of this application may be further implemented by designing a protocol stack. In an implementation, a “model obtaining and distribution” functional module may be added to a media access control (media access control, MAC) layer of a protocol stack, as shown in FIG. 9. The functional module has functions of the third device in the foregoing method embodiments, that is, the functional module may have a model selection function, a model distillation function, a model adjustment function, a model delivery function, a model update function, and the like. Specifically, the “model obtaining and distribution” functional module is added to a controller of a MAC entity. In another implementation, a protocol layer may be newly added to the protocol stack, and the protocol layer includes a “model obtaining and distribution” functional module. In the protocol stack, the newly added protocol layer and the MAC layer may be located at a same layer.

The model selection function of the “model obtaining and distribution” functional module may include: determining a third neural network model from one or more pre-trained neural network models.

The model distillation function may include: when an operation amount of the third neural network model is greater than a first operation amount, and/or a parameter amount of the third neural network model is greater than a first parameter amount, performing distillation on the third neural network model to obtain a first neural network model; or when an operation amount of the third neural network model is less than or equal to a first operation amount, and/or a parameter amount of the third neural network model is less than or equal to a first parameter amount, using the third neural network model as the first neural network model.

The model adjustment function may include: adjusting the first neural network model based on first information, where the first information includes communication resource information and/or channel state information for communication between a first device and a second device.

The model delivery function may include: sending an adjusted first neural network model, or sending a submodel in an adjusted first neural network model, where the adjusted first neural network model is used for the communication between the first device and the second device.

The model update function includes: obtaining a performance indicator for the communication performed between the first device and the second device based on the adjusted first neural network model; and when the performance indicator does not meet a preset condition, obtaining a fifth neural network model obtained by jointly training the adjusted first neural network model by the first device and the second device, and updating the third neural network model in the one or more pre-trained neural network models based on the fifth neural network model.

For specific descriptions of the model selection function, the model distillation function, the model adjustment function, the model delivery function, the model update function, and the like, refer to related descriptions in the foregoing method embodiments. Details are not described herein again.

To implement functions in the foregoing methods provided in embodiments of this application, the third device or the second device may include a hardware structure and/or a software module, and implement the foregoing functions in a form of the hardware structure, the software module, or a combination of the hardware structure and the software module. Whether a function in the foregoing functions is performed in the form of the hardware structure, the software module, or the combination of the hardware structure and the software module depends on particular applications and design constraint conditions of the technical solutions.

FIG. 10 shows a communication apparatus 1000 according to an embodiment of this application. The communication apparatus 1000 may be a component (for example, an integrated circuit or a chip) of a third device, or may be a component (for example, an integrated circuit or a chip) of a second device. Alternatively, the communication apparatus 1000 may be another communication unit, configured to implement the methods in method embodiments of this application. The communication apparatus 1000 may include a communication unit 1001 and a processing unit 1002. The processing unit 1002 is configured to control the communication unit 1001 to perform data/signaling receiving and sending. Optionally, the communication apparatus 1000 may further include a storage unit 1003.

In a possible design, the processing unit 1002 is configured to determine a first neural network model from one or more pre-trained neural network models.

The processing unit 1002 is further configured to adjust the first neural network model based on first information, where the first information includes communication resource information and/or channel state information for communication between a first device and a second device.

The communication unit 1001 is configured to: send an adjusted first neural network model, or send a submodel in an adjusted first neural network model, where the adjusted first neural network model is used for the communication between the first device and the second device.

In an optional implementation, the first neural network model is determined from the one or more pre-trained neural network models based on communication system parameters of the first device and/or communication system parameters of the second device.

The communication system parameters of the first device include a system bandwidth and a frame structure that are supported by the first device, and the communication system parameters of the second device include a system bandwidth and a frame structure that are supported by the second device.

In an optional implementation, the first neural network model is determined based on a third neural network model selected from one or more second neural network models; and the one or more second neural network models are determined from the one or more pre-trained neural network models.

An input dimension of each of the one or more second neural network models is the same as a first input dimension corresponding to each second neural network model, and/or an output dimension of each second neural network model is the same as a first output dimension corresponding to each second neural network model; and the first input dimension and/or the first output dimension corresponding to each second neural network model are/is determined based on a size that is of an RP and that is applicable to the second neural network model, and the communication system parameters of the first device and/or the communication system parameters of the second device.

Optionally, the size of the RP is determined based on a time domain length of the RP and a frequency domain width of the RP.

In an optional implementation, the second neural network model supports a first service type; and the first service type is a service type needed by the first device and the second device.

In an optional implementation, if there are a plurality of second neural network models, the third neural network model is a second neural network model with a largest parameter amount in the plurality of second neural network models.

Alternatively, the third neural network model is a second neural network model with a smallest absolute difference between an operation amount and a first operation amount in a plurality of second neural network models, where the first operation amount is determined based on a computing power and a latency requirement of the first device and/or a computing power and a latency requirement of the second device.

Alternatively, the third neural network model is a second neural network model with a smallest absolute difference between a parameter amount and a first parameter amount in the plurality of second neural network models, where the first parameter amount is determined based on a computing power and storage space of the first device, and/or a computing power and storage space of the second device.

In an optional implementation, the first neural network model is obtained by performing distillation on the third neural network model; and an operation amount of the third neural network model is greater than a first operation amount, and/or a parameter amount of the third neural network model is greater than a first parameter amount.

The first operation amount is determined based on a computing power and a latency requirement of the first device and/or a computing power and a latency requirement of the second device; and the first parameter amount is determined based on the computing power and storage space of the first device and/or the computing power and storage space of the second device.

In an optional implementation, the first neural network model is the third neural network model; and an operation amount of the third neural network model is less than or equal to a first operation amount, and/or a parameter amount of the third neural network model is less than or equal to a first parameter amount.

The first operation amount is determined based on a computing power and a latency requirement of the first device and/or a computing power and a latency requirement of the second device; and the first parameter amount is determined based on the computing power and storage space of the first device and/or the computing power and storage space of the second device.

In an optional implementation, the first neural network model is determined by a model server based on received model request information; and the model request information includes an identifier of the third neural network model, and a first operation amount and/or a first parameter amount.

The first operation amount is determined based on a computing power and a latency requirement of the first device and/or a computing power and a latency requirement of the second device, and the first parameter amount is determined based on the computing power and storage space of the first device and/or the computing power and storage space of the second device.

In an optional implementation, information about each of the one or more pre-trained neural network models is predefined, or is obtained from the model server.

The information about each pre-trained neural network model includes one or more of the following: an identifier, a service type, a size of an RP, an input dimension, an output dimension, a parameter amount, and an operation amount.

In an optional implementation, the adjusted first neural network model is obtained by training a fourth neural network model based on the channel state information in the first information.

The fourth neural network model is obtained by adjusting an input dimension and/or an output dimension of the first neural network model based on a size that is of an RP and that is applicable to the first neural network model and the communication resource information in the first information.

This embodiment of this application is based on a same concept as the foregoing method embodiments, and achieves same technical effects. For a specific principle, refer to descriptions of the foregoing embodiments. Details are not described again.

In another possible design, the communication unit 1001 is configured to: receive an adjusted first neural network model, or receive a submodel in an adjusted first neural network model, where the adjusted first neural network model is used for communication between a first device and a second device.

The adjusted first neural network model is obtained by adjusting a first neural network model based on first information, and the first information includes communication resource information and/or channel state information for the communication between the first device and the second device; and the first neural network model is determined from one or more pre-trained neural network models.

The communication unit 1001 is further configured to: perform communication based on the adjusted first neural network model, or perform communication based on the submodel in the adjusted first neural network model.

In an optional implementation, the first neural network model is determined from the one or more pre-trained neural network models based on communication system parameters of the first device and/or communication system parameters of the second device.

The communication system parameters of the first device include a system bandwidth and a frame structure that are supported by the first device, and the communication system parameters of the second device include a system bandwidth and a frame structure that are supported by the second device.

In an optional implementation, the communication unit 1001 is further configured to send the communication system parameters.

In an optional implementation, the first neural network model is determined based on a third neural network model selected from one or more second neural network models; and the one or more second neural network models are determined from the one or more pre-trained neural network models.

An input dimension of each of the one or more second neural network models is the same as a first input dimension corresponding to each second neural network model, and/or an output dimension of each second neural network model is the same as a first output dimension corresponding to each second neural network model. The first input dimension and/or the first output dimension corresponding to each second neural network model are/is determined based on a size that is of an RP and that is applicable to the second neural network model, and the communication system parameters of the first device and/or the communication system parameters of the second device.

Optionally, the size of the RP is determined based on a time domain length of the RP and a frequency domain width of the RP.

In an optional implementation, the second neural network model supports a first service type; and the first service type is a service type needed by the first device and the second device.

In an optional implementation, the communication unit 1001 is further configured to send a needed service type.

In an optional implementation, if there are a plurality of second neural network models, the third neural network model is a second neural network model with a largest parameter amount in the plurality of second neural network models.

Alternatively, the third neural network model is a second neural network model with a smallest absolute difference between an operation amount and a first operation amount in a plurality of second neural network models, where the first operation amount is determined based on a computing power and a latency requirement of the first device and/or a computing power and a latency requirement of the second device.

Alternatively, the third neural network model is a second neural network model with a smallest absolute difference between a parameter amount and a first parameter amount in the plurality of second neural network models, where the first parameter amount is determined based on a computing power and storage space of the first device, and/or a computing power and storage space of the second device.

In an optional implementation, the communication unit 1001 is further configured to: send a computing power and a latency requirement, or send a computing power and storage space, or send a computing power, a latency requirement, and storage space.

In an optional implementation, the first neural network model is obtained by performing distillation on the third neural network model; and an operation amount of the third neural network model is greater than a first operation amount, and/or a parameter amount of the third neural network model is greater than a first parameter amount.

The first operation amount is determined based on a computing power and a latency requirement of the first device and/or a computing power and a latency requirement of the second device; and the first parameter amount is determined based on the computing power and storage space of the first device and/or the computing power and storage space of the second device.

In an optional implementation, the first neural network model is the third neural network model; and an operation amount of the third neural network model is less than or equal to a first operation amount, and/or a parameter amount of the third neural network model is less than or equal to a first parameter amount.

The first operation amount is determined based on a computing power and a latency requirement of the first device and/or a computing power and a latency requirement of the second device; and the first parameter amount is determined based on the computing power and storage space of the first device and/or the computing power and storage space of the second device.

In an optional implementation, the first neural network model is determined by a model server based on received model request information; and the model request information includes an identifier of the third neural network model, and a first operation amount and/or a first parameter amount.

The first operation amount is determined based on a computing power and a latency requirement of the first device and/or a computing power and a latency requirement of the second device, and the first parameter amount is determined based on the computing power and storage space of the first device and/or the computing power and storage space of the second device.

Optionally, information about each neural network model of the one or more pre-trained neural network models is predefined, or is obtained from the model server; and the information about each pre-trained neural network model includes one or more of the following: an identifier, a service type, a size of an RP, an input dimension, an output dimension, a parameter amount, and an operation amount.

In an optional implementation, the adjusted first neural network model is obtained by training a fourth neural network model based on the channel state information in the first information.

The fourth neural network model is obtained by adjusting an input dimension and/or an output dimension of the first neural network model based on a size that is of an RP and that is applicable to the first neural network model and the communication resource information in the first information.

This embodiment of this application is based on a same concept as the foregoing method embodiments, and achieves same technical effects. For a specific principle, refer to descriptions of the foregoing embodiments. Details are not described again.

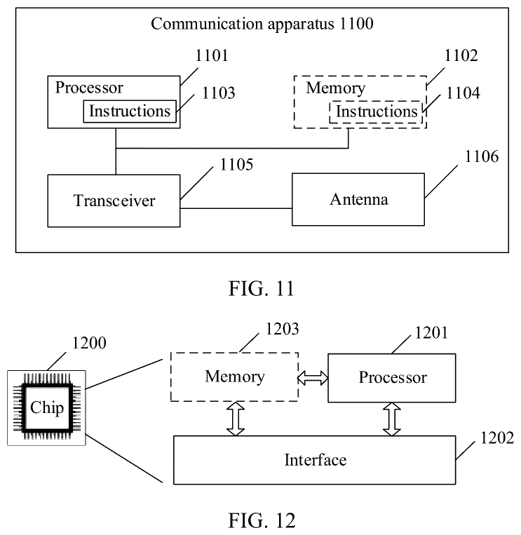

An embodiment of this application further provides a communication apparatus 1100, as shown in FIG. 11. The communication apparatus 1100 may be a third device or a second device, or may be a chip, a chip system, a processor, or the like that supports a third device in implementing the foregoing methods, or may be a chip, a chip system, a processor, or the like that supports a second device in implementing the foregoing methods. The apparatus may be configured to implement the methods described in the foregoing method embodiments. For details, refer to descriptions in the foregoing method embodiments.

The communication apparatus 1100 may include one or more processors 1101. The processor 1101 may be a general-purpose processor, a dedicated processor, or the like. For example, the processor may be a baseband processor, a digital signal processor, an application-specific integrated circuit, a field programmable gate array or another programmable logic device, a discrete gate or a transistor logic device, a discrete hardware component, or a central processing unit (Central Processing Unit, CPU). The baseband processor may be configured to process a communication protocol and communication data. The central processing unit may be configured to: control the communication apparatus (for example, a base station, a baseband chip, a terminal, a terminal chip, a distributed unit (distributed unit, DU), or a central unit (central unit, CU)), execute a software program, and process data of the software program.

Optionally, the communication apparatus 1100 may include one or more memories 1102, and the memory may store instructions 1104. The instructions may be run on the processor 1101, to enable the communication apparatus 1100 to perform the methods described in the foregoing method embodiments. Optionally, the memory 1102 may further store data. The processor 1101 and the memory 1102 may be disposed separately, or may be integrated together.

The memory 1102 may include but is not limited to a non-volatile memory, for example, a hard disk drive (hard disk drive, HDD) or a solid-state drive (solid-state drive, SSD), a random access memory (random access memory, RAM), an erasable programmable read-only memory (erasable programmable ROM, EPROM), a ROM or a compact disc read-only memory (compact disc read-only memory, CD-ROM), or the like.

Optionally, the communication apparatus 1100 may further include a transceiver 1105 and an antenna 1106. The transceiver 1105 may be referred to as a transceiver unit, a transceiver, a transceiver circuit, or the like, and is configured to implement a transceiver function. The transceiver 1105 may include a receiver and a transmitter. The receiver may be referred to as a receiver, a receiver circuit, or the like, and is configured to implement a receiving function. The transmitter may be referred to as a transmitter machine, a transmitter circuit, or the like, and is configured to implement a sending function.

When the communication apparatus 1100 is the third device, the transceiver 1105 is configured to perform S103 in the communication method shown in FIG. 4, and is configured to perform S201, S205, S208, S210, S211, S213, and S214 in the communication method shown in FIG. 9. The processor 1101 is configured to perform S101 and S102 in the communication method shown in FIG. 4, and is configured to perform S202 to S204, S209, S212, and S213 in the communication method shown in FIG. 9.

When the communication apparatus 1100 is the second device, the transceiver 1105 is configured to perform S103 in the communication method shown in FIG. 4, and is configured to perform S201, S210, S211, and S213 in the communication method shown in FIG. 9. The processor 1101 is configured to perform S104 in the communication method shown in FIG. 4, and is configured to perform S213 in the communication method shown in FIG. 9.

In another possible design, the processor 1101 may include a transceiver configured to implement receiving and sending functions. For example, the transceiver may be a transceiver circuit, an interface, or an interface circuit. The transceiver circuit, the interface, or the interface circuit configured to implement the receiving and sending functions may be separated, or may be integrated together. The transceiver circuit, the interface, or the interface circuit may be configured to: read and write code/data. Alternatively, the transceiver circuit, the interface, or the interface circuit may be configured to perform signal transmission or transfer.

In still another possible design, optionally, the processor 1101 may store instructions 1103, and the instructions 1103 are run on the processor 1101, to enable the communication apparatus 1100 to perform the methods described in the foregoing method embodiments. The instructions 1103 may be fixed in the processor 1101. In this case, the processor 1101 may be implemented by hardware.

In still another possible design, the communication apparatus 1100 may include a circuit. The circuit may implement a sending, receiving, or communication function in the foregoing method embodiments. The processor and the transceiver described in this embodiment of this application may be implemented on an integrated circuit (integrated circuit, IC), an analog IC, a radio frequency integrated circuit (radio frequency integrated circuit, RFIC), a mixed-signal IC, an application-specific integrated circuit (application-specific integrated circuit, ASIC), a printed circuit board (printed circuit board, PCB), an electronic device, or the like. The processor and the transceiver may alternatively be manufactured by using various IC technologies, for example, a complementary metal oxide semiconductor (complementary metal oxide semiconductor, CMOS), an N-type metal oxide semiconductor (NMOS), a P-type metal oxide semiconductor (PMOS), a bipolar junction transistor (bipolar junction transistor, BJT), a bipolar CMOS (BiCMOS), silicon germanium (SiGe), and gallium arsenide (GaAs).

The communication apparatus described in the foregoing embodiment may be the third device or the second device. However, the scope of the communication apparatuses described in embodiments of this application is not limited thereto, and structures of the communication apparatuses may not be limited by FIG. 11. The communication apparatus may be an independent device or may be a part of a large device. For example, the communication apparatus may be:
(1) an independent integrated circuit IC, a chip, a chip system, or a subsystem;
(2) a set with one or more ICs, where optionally, the IC set may alternatively include a storage component configured to store data and instructions;
(3) an ASIC, for example, a modulator (modulator);
(4) a module that can be embedded in another device;
(5) a receiver, a terminal, an intelligent terminal, a cellular phone, a wireless device, a handheld device, a mobile unit, a vehicle-mounted device, a network device, a cloud device, an artificial intelligence device, or the like; or
(6) others.

For a case in which the communication apparatus may be a chip or a chip system, refer to a diagram of a structure of a chip shown in FIG. 12. The chip 1200 shown in FIG. 12 includes a processor 1201 and an interface 1202. There may be one or more processors 1201, and there may be a plurality of interfaces 1202. The processor 1201 may be a logic circuit, and the interface 1202 may be an input/output interface, an input interface, or an output interface. The chip 1200 may further include a memory 1203.

In a design, for a case in which the chip is configured to implement a function of the first device in this embodiment of this application:

The processor 1201 is configured to determine a first neural network model from one or more pre-trained neural network models.

The processor 1201 is further configured to adjust the first neural network model based on first information, where the first information includes communication resource information and/or channel state information for communication between a first device and a second device.

The interface 1202 is configured to: send an adjusted first neural network model, or send a submodel in an adjusted first neural network model, where the adjusted first neural network model is used for the communication between the first device and the second device.

In another design, for a case in which the chip is configured to implement a function of the second device in this embodiment of this application:

The interface 1202 is configured to: receive an adjusted first neural network model, or receive a submodel in an adjusted first neural network model, where the adjusted first neural network model is used for communication between a first device and a second device.

The adjusted first neural network model is obtained by adjusting a first neural network model based on first information, and the first information includes communication resource information and/or channel state information for the communication between the first device and the second device; and the first neural network model is determined from one or more pre-trained neural network models.

The interface 1202 is further configured to: perform communication based on the adjusted first neural network model, or perform communication based on the submodel in the adjusted first neural network model.

In this embodiment of this application, the communication apparatus 1100 and the chip 1200 may further perform implementations described in the foregoing communication apparatus 1000. A person skilled in the art may further understand that various illustrative logical blocks (illustrative logic blocks) and steps (steps) that are listed in embodiments of this application may be implemented by using electronic hardware, computer software, or a combination thereof. Whether the functions are implemented by using hardware or software depends on particular applications and a design requirement of the entire system. A person skilled in the art may use various methods to implement the described functions for each particular application, but it should not be considered that the implementation goes beyond the scope of embodiments of this application.

This embodiment of this application is based on a same concept as the communication method shown in FIG. 4 and the communication method shown in FIG. 9, and achieves same technical effects. For a specific principle, refer to descriptions of the communication method shown in FIG. 4 and the communication method shown in FIG. 9. Details are not described again.

A person skilled in the art may further understand that various illustrative logical blocks (illustrative logic blocks) and steps (steps) that are listed in embodiments of this application may be implemented by using electronic hardware, computer software, or a combination thereof. Whether the functions are implemented by using hardware or software depends on particular applications and a design requirement of the entire system. A person skilled in the art may use various methods to implement the described functions for each particular application, but it should not be considered that the implementation goes beyond the scope of embodiments of this application.

This application further provides a computer-readable storage medium, configured to store computer software instructions. When the instructions are executed by a communication apparatus, a function in any one of the foregoing method embodiments is implemented.

This application further provides a computer program product, configured to store computer software instructions. When the instructions are executed by a communication apparatus, a function in any one of the foregoing method embodiments is implemented.

This application further provides a computer program. When the computer program is run on a computer, a function in any one of the foregoing method embodiments is implemented.

This application further provides a communication system. The system includes at least one first device and at least one second device in the foregoing aspects. In another possible design, the system further includes at least one model server in the foregoing aspects. In still another possible design, the system may further include another device that interacts with the first device and the second device in the solutions provided in this application.

All or some of the foregoing embodiments may be implemented by using software, hardware, firmware, or any combination thereof. When software is used to implement the embodiments, all or some of the embodiments may be implemented in a form of a computer program product. The computer program product includes one or more computer instructions. When the computer instructions are loaded and executed on a computer, the procedure or functions according to embodiments of this application are all or partially generated. The computer may be a general-purpose computer, a dedicated computer, a computer network, or another programmable apparatus. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (digital subscriber line, DSL)) or wireless (for example, infrared, radio, or microwave) manner. The computer-readable storage medium may be any usable medium accessible by the computer, or a data storage device, for example, a server or a data center, integrating one or more usable media. The usable medium may be a magnetic medium (for example, a floppy disk, a hard disk drive, or a magnetic tape), an optical medium (for example, a digital video disc (digital video disc, DVD)), a semiconductor medium (for example, an SSD), or the like.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

1. A communication method implemented by a communication apparatus, comprising:
determining a first neural network model from one or more pre-trained neural network models;
adjusting the first neural network model based on first information, wherein the first information comprises communication resource information and/or channel state information for communication between a first device and a second device; and
sending an adjusted first neural network model, or sending a submodel in an adjusted first neural network model, wherein
the adjusted first neural network model is used for the communication between the first device and the second device.

2. The method according to claim 1, wherein
the first neural network model is determined from the one or more pre-trained neural network models based on one or more communication system parameters of the first device and/or one or more communication system parameters of the second device, and wherein the communication system parameters of the first device comprise a system bandwidth and a frame structure that are supported by the first device, and the communication system parameters of the second device comprise a system bandwidth and a frame structure that are supported by the second device.

3. The method according to claim 2, wherein
the first neural network model is determined based on a third neural network model selected from one or more second neural network models,
the one or more second neural network models are determined from the one or more pre-trained neural network models,
an input dimension of each of the one or more second neural network models is the same as a first input dimension corresponding to each second neural network model, and/or an output dimension of each second neural network model is the same as a first output dimension corresponding to each second neural network model, and
the first input dimension and/or the first output dimension corresponding to each second neural network model are/is determined based on a size that is of a resource patch (RP) and that is applicable to the second neural network model, and the communication system parameters of the first device and/or the communication system parameters of the second device.

4. The method according to claim 3, wherein the size of the RP is determined based on a time domain length of the RP and a frequency domain width of the RP.

5. The method according to claim 3, wherein the second neural network model supports a first service type, and the first service type is a service type needed by the first device and the second device.

6. The method according to claim 3, wherein
the first neural network model is obtained by performing distillation on the third neural network model, and
an operation amount of the third neural network model is greater than a first operation amount, and/or a parameter amount of the third neural network model is greater than a first parameter amount, wherein
the first operation amount is determined based on a computing power and a latency requirement of the first device and/or a computing power and a latency requirement of the second device, and the first parameter amount is determined based on the computing power and storage space of the first device and/or the computing power and storage space of the second device.

7. The method according to claim 3, wherein
the first neural network model is the third neural network model, and
an operation amount of the third neural network model is less than or equal to a first operation amount, and/or a parameter amount of the third neural network model is less than or equal to a first parameter amount, and wherein
the first operation amount is determined based on a computing power and a latency requirement of the first device and/or a computing power and a latency requirement of the second device, and the first parameter amount is determined based on the computing power and storage space of the first device and/or the computing power and storage space of the second device.

8. The method according to claim 3, wherein
the first neural network model is determined by a model server based on received model request information,
the model request information comprises an identifier of the third neural network model, and a first operation amount and/or a first parameter amount, and wherein
the first operation amount is determined based on a computing power and a latency requirement of the first device and/or a computing power and a latency requirement of the second device, and the first parameter amount is determined based on the computing power and storage space of the first device and/or the computing power and storage space of the second device.

9. The method according to claim 8, wherein
information about each of the one or more pre-trained neural network models is predefined, or is obtained from the model server, and
the information about each pre-trained neural network model comprises one or more of the following: an identifier, a service type, a size of an RP, an input dimension, an output dimension, a parameter amount, or an operation amount.

10. The method according to claim 1, wherein
the adjusted first neural network model is obtained by training a fourth neural network model based on the channel state information in the first information, and
the fourth neural network model is obtained by adjusting an input dimension and/or an output dimension of the first neural network model based on a size that is of an RP and that is applicable to the first neural network model and the communication resource information in the first information.

11. A communication apparatus, comprising:
one or more processors, configured to determine a first neural network model from one or more pre-trained neural network models, wherein
the one or more processors are further configured to adjust the first neural network model based on first information, and the first information comprises communication resource information and/or channel state information for communication between a first device and a second device; and
a transceiver, configured to send an adjusted first neural network model, or send a submodel in an adjusted first neural network model, wherein the adjusted first neural network model is used for the communication between the first device and the second device.

12. The apparatus according to claim 11, wherein
the first neural network model is determined from the one or more pre-trained neural network models based on communication system parameters of the first device and/or communication system parameters of the second device, wherein the communication system parameters of the first device comprise a system bandwidth and a frame structure that are supported by the first device, and the communication system parameters of the second device comprise a system bandwidth and a frame structure that are supported by the second device.

13. The apparatus according to claim 12, wherein
the first neural network model is determined based on a third neural network model selected from one or more second neural network models,
the one or more second neural network models are determined from the one or more pre-trained neural network models,
an input dimension of each of the one or more second neural network models is the same as a first input dimension corresponding to each second neural network model, and/or an output dimension of each second neural network model is the same as a first output dimension corresponding to each second neural network model, and wherein
the first input dimension and/or the first output dimension corresponding to each second neural network model are/is determined based on a size that is of a resource patch (RP) and that is applicable to the second neural network model, and the communication system parameters of the first device and/or the communication system parameters of the second device.

14. The method according to claim 13, wherein the size of the RP is determined based on a time domain length of the RP and a frequency domain width of the RP.

15. The apparatus according to claim 13, wherein the second neural network model supports a first service type, and the first service type is a service type needed by the first device and the second device.

16. A communication apparatus, comprising:
a transceiver, configured to: receive an adjusted first neural network model, or receive a submodel in an adjusted first neural network model,
wherein the adjusted first neural network model is used for communication between a first device and a second device,
wherein the adjusted first neural network model is obtained by adjusting a first neural network model based on first information, and the first information comprises communication resource information and/or channel state information for the communication between the first device and the second device,
wherein the first neural network model is determined from one or more pre-trained neural network models and
wherein the transceiver is further configured to: perform communication based on the adjusted first neural network model, or perform communication based on the submodel in the adjusted first neural network model.

17. The apparatus according to claim 16, wherein
the first neural network model is determined from the one or more pre-trained neural network models based on communication system parameters of the first device and/or communication system parameters of the second device, wherein the communication system parameters of the first device comprise a system bandwidth and a frame structure that are supported by the first device, and the communication system parameters of the second device comprise a system bandwidth and a frame structure that are supported by the second device.

18. The apparatus according to claim 17, wherein
the first neural network model is determined based on a third neural network model selected from one or more second neural network models,
the one or more second neural network models are determined from the one or more pre-trained neural network models,
an input dimension of each of the one or more second neural network models is the same as a first input dimension corresponding to each second neural network model, and/or an output dimension of each second neural network model is the same as a first output dimension corresponding to each second neural network model, and
wherein the first input dimension and/or the first output dimension corresponding to each second neural network model are/is determined based on a size that is of a resource patch (RP) and that is applicable to the second neural network model, and the communication system parameters of the first device and/or the communication system parameters of the second device.

19. The apparatus according to claim 18, wherein
the first neural network model is obtained by performing distillation on the third neural network model, and
an operation amount of the third neural network model is greater than a first operation amount, and/or a parameter amount of the third neural network model is greater than a first parameter amount, wherein
the first operation amount is determined based on a computing power and a latency requirement of the first device and/or a computing power and a latency requirement of the second device; and the first parameter amount is determined based on the computing power and storage space of the first device and/or the computing power and storage space of the second device.

20. The apparatus according to claim 18, wherein
the first neural network model is the third neural network model, and
an operation amount of the third neural network model is less than or equal to a first operation amount, and/or a parameter amount of the third neural network model is less than or equal to a first parameter amount, and wherein
the first operation amount is determined based on a computing power and a latency requirement of the first device and/or a computing power and a latency requirement of the second device, and the first parameter amount is determined based on the computing power and storage space of the first device and/or the computing power and storage space of the second device.
